(19) United States
(12) Patent Application Publication
(10) Pub. No.: US 2025/0028098 A1
(43) Pub. Date: Jan. 23, 2025

(54) OPTICAL ELEMENT, OPTICAL SYSTEM, LENS APPARATUS, AND IMAGE PICKUP APPARATUS

(71) Applicant: CANON KABUSHIKI KAISHA, Tokyo (JP)

(72) Inventor: Tomohiko ISHIBASHI, Tochigi (JP)

(21) Appl. No.: 18/757,616

(22) Filed: Jun. 28, 2024

(30) Foreign Application Priority Data
Jul. 19, 2023 (JP) 2023-117275

(51) Int. Cl. G02B 5/18; G02B 27/42

(52) U.S. Cl. CPC G02B 5/1871; G02B 5/1814; G02B 5/1857; G02B 5/1885; G02B 27/4205

(57) ABSTRACT

An optical element includes a substrate, and a plurality of annulus sections concentrically arranged on the substrate. The plurality of annulus sections include a first annulus section that includes a first area where a base layer is provided, and a second area where the base layer is not provided. A plurality of first structures having mutually different widths in a radial direction are arranged in the first area. A plurality of second structures having mutually different widths in the radial direction are arranged in the second area.

### BACKGROUND

### Technical Field

One of the aspects of the embodiments relates to an optical element, an optical system, a lens apparatus, and an image pickup apparatus.

### Description of Related Art

In order to reduce the size of an optical system in an image pickup apparatus, etc., an optical element (metalens) has conventionally been known that has a fine uneven (undulate, relief, or textured) structure formed on the surface of a substrate and provides a light condensing or diverging effect using diffraction. Japanese Patent Laid-Open No. 2021-99400 discloses a metalens as a lens for terahertz waves.

In order to increase the diffraction efficiency (a ratio of a light amount directed toward a specific diffraction angle to an incident light amount) in the optical element having the fine uneven structure, a repetition period (pitch) of the fine uneven structure may be smaller than the wavelength of the incident light. A smooth phase distribution may be realized by changing the shape of the fine uneven structure for each pitch.

However, as the pitch reduces, the aspect ratio of the fine uneven structure increases. Thus, it becomes difficult to form the fine uneven structure and maintain its shape, and the fine uneven structure may be deformed by a slight load, temperature, pressure, or the like.

### SUMMARY

An optical element according to one aspect of the disclosure includes a substrate, and a plurality of annulus sections concentrically arranged on the substrate. The plurality of annulus sections include a first annulus section includes a first area where a base layer is provided, and a second area where the base layer is not provided. A plurality of first structures having mutually different widths in a radial direction are arranged in the first area. A plurality of second structures having mutually different widths in the radial direction are arranged in the second area. An optical system, a lens apparatus, and an image pickup apparatus each having the above optical element also constitute another aspect of the disclosure.

Further features of various embodiments of the disclosure will become apparent from the following description of embodiments with reference to the attached drawings.

### BRIEF DESCRIPTION OF THE DRAWINGS

FIGS. 1A, 1B, and 1C are configuration diagrams of an optical element according to each example.

FIG. 2 is a configuration diagram of an optical element according to a comparative example.

FIG. 3 illustrates a relationship between the shape of an uneven element of the optical element and a phase modulation amount in each example.

FIG. 4 illustrates a relationship between the shape of an uneven element of the optical element and a phase modulation amount in the comparative example.

FIGS. 5A, 5B, and 5C explain a method for manufacturing the optical element according to each example.

FIG. 6 explains an offset layer according to each example.

FIG. 7 explains a modulation amount of a normalized phase in a radial direction of the optical element according to each example.

FIG. 8 explains a width of the uneven element in the radial direction of each of the optical elements according to each example and comparative example.

FIGS. 9A and 9B explain an element filling rate according to each example.

FIGS. 10A, 10B, 10C, and 10D explain an offset of a base layer according to each example.

FIGS. 11A, 11B, 11C, and 11D explain the shape of the uneven element according to each example.

FIG. 12 is a configuration diagram of an optical element according to Example 16.

FIGS. 13A and 13B are configuration diagrams of an optical element according to Example 19.

FIG. 14 explains an optical system including the optical element according to any one of the above examples.

FIG. 15 explains an image pickup apparatus having the optical element according to any one of the above examples.

### DESCRIPTION OF THE EMBODIMENTS

Referring now to the accompanying drawings, a detailed description will be given of embodiments according to the disclosure.

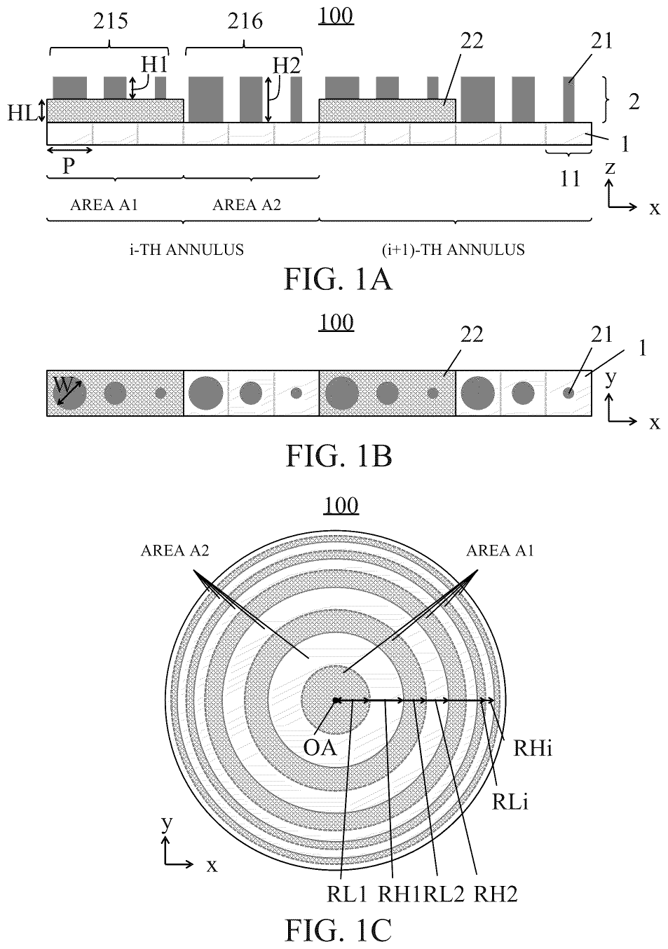

Referring now to FIGS. 1A, 1B, and 1C, a description will be given of the optical element 100 according to each example. FIGS. 1A, 1B, and 1C are configuration diagrams of the optical element 100. FIG. 1A is an enlarged sectional view of the optical element 100 (on an xz plane) viewed from a y-axis direction. FIG. 1B is an enlarged top view of the optical element 100 (on an xy plane) viewed from a z-axis direction (optical axis direction). FIG. 1C is an overall top view of the optical element 100 (on the xy plane) viewed from the z-axis direction (optical axis direction). In each example, the optical axis direction of the optical element 100 and the thickness direction of the substrate 1 accord with the z-axis direction.

The optical element 100 according to each example includes a substrate 1 and an uneven structure (pillars) 2 formed on the substrate 1. The uneven structure 2 includes a plurality of uneven elements (a plurality of structures) 21 including at least one of concave portions or convex portions periodically arranged in the radial direction and a base layer 22 having a substantially constant thickness in the thickness direction (z-axis direction) of the substrate 1. The term “substantially constant” means that although the thickness of the base layer 20 may be as constant as possible, the thickness does not have to be strictly constant due to manufacturing errors, etc. The thickness of the base layer 22 is, for example, within a range that satisfies the following inequality.

The following inequality (1) is satisfied:

$$1. \leq A / B < 1.5 \qquad ( 1 )$$

where A and B are a maximum thickness and a minimum thickness of the base layer 22 in the substrate 1, respectively.

Inequality (1) may be replaced with inequality (1a) below:

$$1. 00 \leq A / B < 1.2 \qquad ( 1 a )$$

Inequality (1) may be replaced with inequality (1b) below:

$$1. 00 \leq A / B < 1.15 \qquad ( 1 b )$$

Inequality (1) may be replaced with inequality (1c) below:

$$1. 00 \leq A / B < 1.10 \qquad ( 1 c )$$

Inequality (1) may be replaced with inequality (1d) below:

$$1. 00 \leq A / B < 1.05 \qquad ( 1 d )$$

Forming a periodic phase difference (annulus sections or annuli) in the radial direction of the substrate 1 can provide the incident light with a condensing or diverging effect. The optical element 100 includes a plurality of annulus sections that include a first annulus section (i-th annulus section) and a second annulus section ((i+1)-th annulus section) disposed along the radial direction so as to extend in the circumferential direction with respect to the center of the optical element 100. Each of the plurality of annulus sections has an area A1 (first area) and an area A2 (second area) disposed along the radial direction of the optical element 100. In each example, at least one of the plurality of annulus sections may have the areas A1 and A2, but the plurality of annulus sections may have the areas A1 and A2, and all the annulus sections may have the areas A1 and A2.

The plurality of uneven elements (the plurality of structures) 21 have a plurality of first structures 215 disposed in the areas A1 and a plurality of second structures 216 disposed in the areas A2. In the areas A1, the plurality of first structures 215 are formed on the substrate 1 via the base layer 22. In the areas A2, the plurality of second structures 216 are formed directly on the substrate 1 (without the base layer 22). The plurality of first structures 215 have different widths in the radial direction. Similarly, the plurality of second structures 216 have different widths in the radial direction. However, all of the widths of the plurality of first structures 215 do not need to be different, and some of them may be the same. This is similarly applicable to the widths of the plurality of second structures 216.

The substrate 1 is a transparent flat plate made of synthetic quartz. The substrate 1 may be a plane mirror that reflects incident light, or may be a curved surface having an arbitrary curvature. The material of the substrate 1 is not limited to synthetic quartz, and may be inorganic glass, organic materials such as plastics, ceramics, metals, etc. The uneven structure 2 is formed on the surface of the substrate 1, and provides a phase difference to the light passing through the uneven structure 2, thereby giving a light condensing or diverging effect. Each example obtains a light condensing effect almost equivalent to that of a diffractive optical element by forming a phase distribution by the annulus sections in which a phase difference of 2nπ (n=1, 2, . . . , an integer representing a designed diffraction order or a diffraction order) concentrically and periodically repeats.

The uneven structure 2 has uneven elements 21 and the base layer 22. The uneven elements 21 consist of periodically arranged concave or convex portions. In each example, the uneven elements 21 consist of convex cylindrical elements made of a dielectric material Si₃N₄. The shape of the uneven element 21 is not limited to a convex cylindrical element, but may be a polygonal column, a polygonal pyramid, a cone, an arbitrary concave element, or a combination thereof. The material of the uneven elements 21 may be TiO₂, GaN, GaP, GaAs, Si, SiC, Al₂O₃, SiO₂, or the like.

The uneven element 21 is a convex cylindrical element disposed at the center of a unit division segment 11 divided into squares in the radial direction of the substrate 1. Due to the width (pitch) of the segments 11 smaller than the wavelength of the incident light, the light is effectively phase-modulated according to the effective refractive index required from a filling rate (element filling rate) that occupies a unit division (segment) regardless of the shape of the uneven element 21. For example, in a case where the incident light is in the visible light range (400 to 700 nm), the pitch (array period) P [nm] may be less than 400 nm, and the pitch P may be further reduced because unnecessary diffracted light can be suppressed. The i-th annulus section (i=1, 2, . . . ) has the area A1 having the approximately flat base layer 22 disposed between the plurality of uneven elements 21 and the substrate 1 and the area A2 having no approximately flat base layer 22 disposed between the plurality of uneven elements 21 and the substrate 1.

The base layer 22 has an approximately constant thickness in the thickness direction of the substrate 1, and is made of Si₃N₄, which is the same material as that of the uneven element 21 in each example. Each of the areas A1 and A2 in the i-th annulus section has a plurality of uneven elements 21, and each shape has a different width in the radial direction of the substrate 1. Thereby, a phase distribution of 2nπ in the annulus section is formed. In the direction orthogonal to the optical axis, RLi and RHi are radii of the areas A1 and A2 in the i-th annulus section from the optical axis, respectively. As understood from FIG. 1C, the areas A1 and A2 are alternately arranged concentrically in the direction orthogonal to the optical axis (z-axis) so that RLi<RHi.

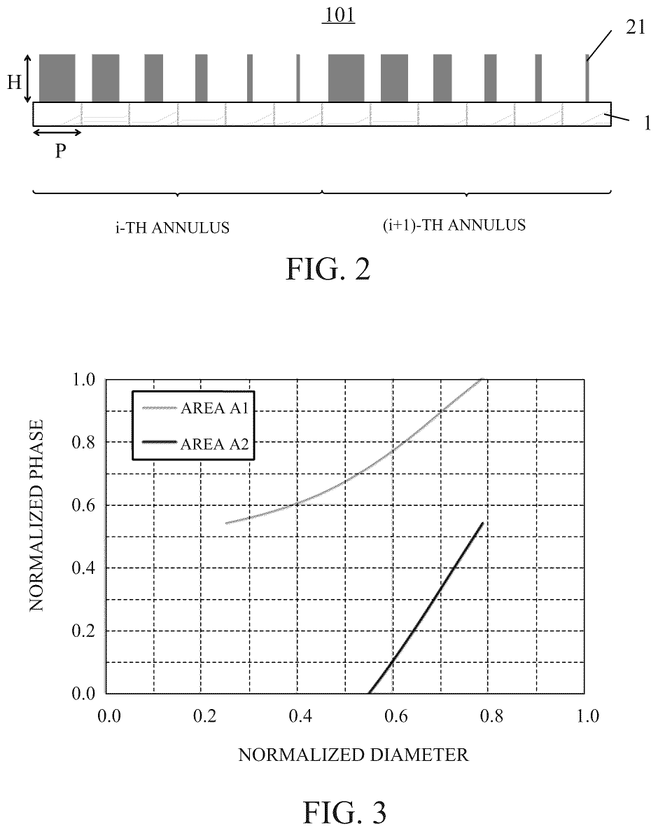

Referring now to FIG. 2, a description will be given of an optical element 101 having no base layer 22 according to a comparative example. FIG. 2 is a configuration diagram of the optical element 101 according to the comparative example. In order to form a phase distribution of 2nπ within the annulus section, the width (diameter) of the convex cylindrical element as the uneven element 21 is changed and the element filling rate of the uneven element 21 within the segment is changed. That is, the element filling rate decreases in order from a convex cylindrical element having a large diameter to a convex cylindrical element having a small diameter, and a desired phase distribution is formed. In the optical element 101 illustrated in FIG. 2, the element filling rate is adjusted only by the diameter of the convex cylindrical element, so the diameter is significantly changed. Therefore, the minimum diameter of the convex cylindrical element tends to decrease, and the aspect ratio (the ratio of the height to the width of the uneven element 21 (height/width)) tends to increase. For a relatively elongate element with a large aspect ratio, the shape may deform, tilt, or peel off in a case where a load is applied due to contact or vibration, or in a case where an external factor such as temperature or pressure changes. Accordingly, each example forms the uneven structure 2 without increasing the aspect ratio by providing the base layer 22 in the annulus section to raise the phase modulation amount in the area A2, thereby reducing a width change amount of the uneven element 21.

FIG. 3 illustrates a relationship between the shape of the uneven element 21 of the optical element 100 and the phase modulation amount according to each example, and relates to the diameter of the convex cylindrical element that is the uneven element 21 and the phase modulation amount. In FIG. 3, the horizontal axis represents the diameter W of the convex cylindrical element (normalized diameter normalized by the pitch P of the segment), and the vertical axis represents the normalized phase obtained by normalizing the phase modulation amount by 2π. In a case where the normalized phase is in a range from 0 to 0.54, the normalized diameter of the convex cylindrical element in the area A2 having no base layer 22 changes from 0.552 to 0.790. In a case where the normalized phase is in a range from 0.54 to 1, the normalized diameter of the convex cylindrical element in the area A1 having the base layer 22 changes from 0.253 to 0.790. Thereby, a phase modulation amount of the normalized phase 0 to 1 can be obtained, the maximum value AR1 of the aspect ratio of the uneven element 21 in the area A1 is 7.2, and the maximum value AR2 of the aspect ratio of the uneven element 21 in the area A2 is 6.6.

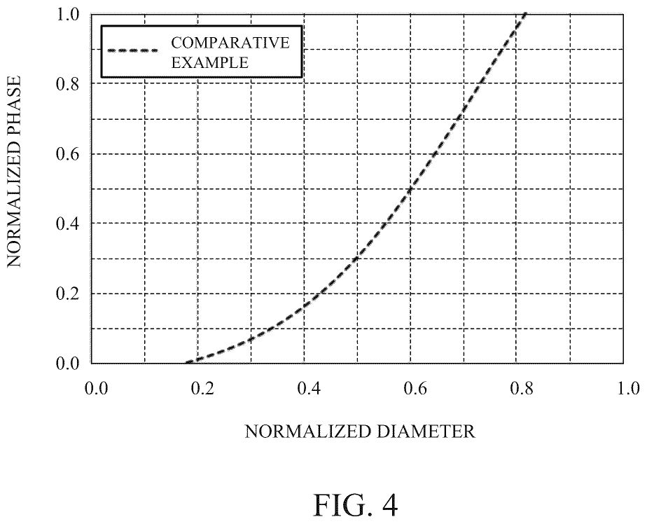

FIG. 4 illustrates a relationship between the shape of the uneven element 21 and the phase modulation amount of the optical element 101 according to the comparative example, and relates to the diameter of the convex cylindrical element and the phase modulation amount in the optical element 101 having no base layer 22. In FIG. 4, the horizontal and vertical axes are similar to those of FIG. 3, respectively. In FIG. 4, in order to obtain the phase modulation amount of normalized phase 0 to 1, the normalized diameter is to be changed from 0.177 to 0.823, and the maximum value of the aspect ratio is 20.7, which is larger than that in a case where the base layer is provided. It is thereby understood that providing the base layer 22 can suppress the aspect ratio of the uneven element 21.

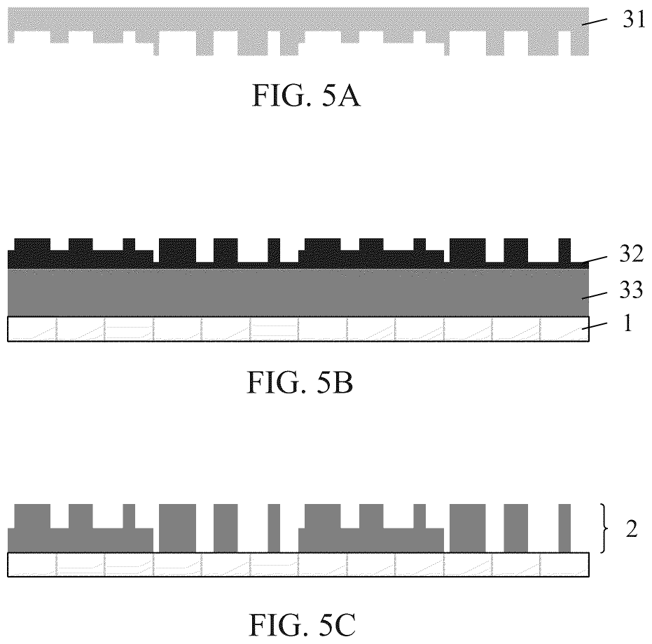

Referring now to FIGS. 5A, 5B, and 5C, a description will be given of a method for manufacturing the optical element 100 according to each example. The optical element 100 can be manufactured using lithography technology. FIGS. 5A, 5B, and 5C explain a method for manufacturing the optical element 100, and illustrate the step for manufacturing the optical element 100 using nanoimprint lithography. FIG. 5A illustrates a mold 31, which has a shape that is an inversion of the uneven shape of the uneven element 21 formed by an electron beam, a laser, or the like. As illustrated in FIG. 5B, a resist material 32 is applied to a film 33 deposited on the substrate 1, the mold 31 is pressed, and ultraviolet rays or the like are irradiated, so that an inverted shape of the uneven shape of the mold 31 is formed on the resist material 32. Thereafter, as illustrated in FIG. 5C, the mold 31 is peeled off and developed so that the uneven shape of the resist material 32 is transferred to the film 33, and thereby the uneven structure 2 is formed on the substrate 1 of the optical element 100. In each example, the method for manufacturing the uneven structure 2 is not limited to nanoimprint lithography, and another method may be used, such as directly forming the uneven structure 2 using an electron beam, a laser, or the like.

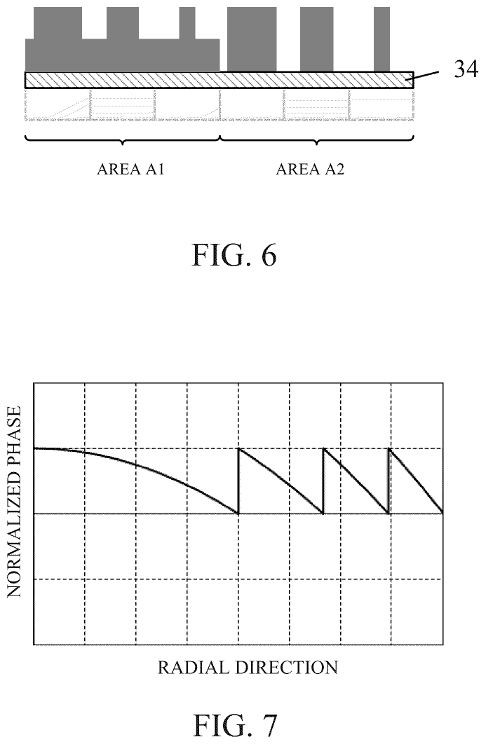

FIG. 6 explains an offset layer 34 according to each example. As illustrated in FIG. 6, instead of a structure in which the uneven structure 2 is directly formed on the substrate 1 as illustrated in FIG. 5C, the offset layer 34 disposed crossing the areas A1 and A2 may be provided. The substrate 1 may include the offset layer 34 and be treated as the substrate 1.

In each example, the base layer 22 may be made of the same material as that of the uneven element 21. As illustrated in FIG. 5B, it is relatively easy to prepare a material with a uniform thickness like the film 33. Thus, in forming the base layer 22 and the uneven structure 2 based on the film 33, the base layer 22 may be made of the same material as that of the uneven element 21.

In each example, the following inequality (2) may be satisfied:

$$0. 20 \leq H 1 / H 2 \leq 0.90 \qquad ( 2 )$$

where H1 is a height (first height) of each of the plurality of first structures 215 in the area A1, and H2 is a height (second height) of each of the plurality of second structures 216 in the area A2. By satisfying inequality (2), the manufacturing process becomes simple and the formation of the uneven elements 21 becomes easier.

Inequality (2) relates to the shape of the uneven element 21. Since the base layer 22 is disposed in the area A1, even if the height H1 of the uneven elements 21 in the area A1 is lower than that in the area A2, the phase modulation amount can be increased. Therefore, a shape in which the aspect ratio of the uneven elements 21 is reduced, particularly in the area A1, may be realized.

In a case where the value becomes lower than the lower limit of inequality (2), the height H1 of the uneven element 21 in the area A1 becomes relatively low, and the phase modulation amount cannot be increased in a case where the width of the uneven element 21 in the area A1 is changed. At this time, in order to obtain the desired phase modulation amount, the width of the uneven element 21 in the area A1 is to be relatively significantly changed, so that the effect of reducing the aspect ratio in the area A1 cannot be obtained. In each example, the lower limit of inequality (2) is 0.25, 0.30, 0.32, 0.34, 0.35, 0.36, 0.38, or 0.40.

On the other hand, in a case where the value becomes higher than the upper limit of inequality (2), the height H2 of the uneven element 21 in the area A2 becomes relatively low, and the phase modulation amount in changing the width of the uneven element 21 in the area A2 cannot be increased. At this time, in order to obtain the desired phase modulation amount, the width of the uneven element 21 in the area A2 is to be relatively significantly changed, so that the effect of reducing the aspect ratio in the area A2 cannot be obtained. The upper limit of inequality (2) may be changed to 0.88, 0.86, 0.84, 0.82, 0.80, 0.78, 0.76, 0.74, 0.72, 0.70, 0.69, 0.68, 0.67, 0.66, or 0.65.

In each example, the heights H1 of the plurality of first structures 215 do not have to be the same, and may be different from each other. This point is also applied to the heights H2 of the plurality of second structures 216.

In each example, the following inequality (3) may be satisfied:

$$0.8 \leq ( H 1 + HL ) / H 2 \leq 1.2 \qquad ( 3 )$$

where HL is a height of the base layer 22 in the area A1. The height HL is, for example, an average height of the base layer 22 in the area A1. The following inequality (3) may be satisfied even if the height HL is a minimum height or the maximum height.

Inequality (3) relates to the heights of the uneven elements 21 and the base layer 22. By satisfying the inequality (3), the tip position of the uneven element 21 in the area A1 and the tip position of the uneven elements 21 in the area A2 relative to the substrate 1 become approximately equivalent. Therefore, in forming the uneven structure 2 from a film having a uniform thickness, a highly stable uneven structure can be realized with a simple process. In a case where the value becomes lower than the lower limit of inequality (3), the height H2 of the uneven elements 21 in the area A2 becomes relatively high, and the effect of reducing the aspect ratio in the area A2 cannot be obtained. Furthermore, a difference in the tip positions of the uneven elements 21 between the areas A1 and A2 increases. Thus, in forming the uneven structure 2 from the film having the uniform thickness, a step of providing a difference in height is to be included. On the other hand, in a case where the value becomes higher than the upper limit of inequality (3), the height H1 of the uneven elements 21 in the area A1 becomes relatively high, and the effect of reducing the aspect ratio in the area A1 cannot be obtained.

In order to further secure the effects of each example, the lower limit of inequality (3) may be changed to 0.82, 0.84, 0.86, 0.88, 0.90, 0.92, 0.94, 0.95, 0.96, 0.97, 0.98, or 0.99. The upper limit of inequality (3) may be changed to 1.18, 1.16, 1.14, 1.12, 1.10, 1.08, 1.06, 1.05, 1.04, 1.03, 1.02, or 1.01.

In a case where the heights of the uneven elements 21 and the base layer 22 have slight undulations in the radial direction of the substrate 1, the average value of the heights of the uneven elements 21 and the base layer 22 in the annulus section may satisfy inequality (3). In addition, inequality (3) may not be satisfied in areas where the effects of each example are not expected, such as an unintended local uneven portion due to manufacturing errors or a structure outside the ray effective portion.

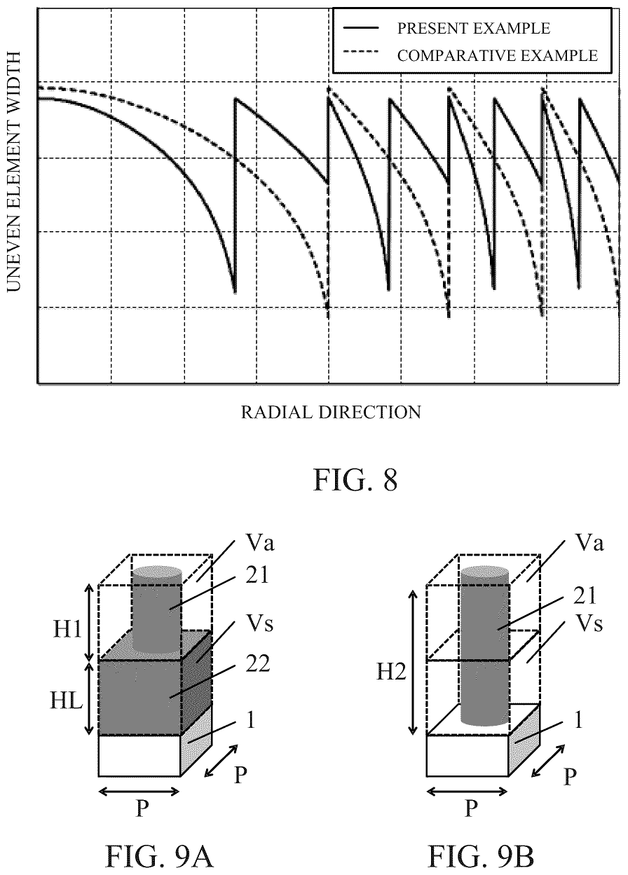

Regarding light traveling in the thickness direction of the substrate 1, a phase modulation amount (phase delay amount) caused by the uneven structure 2 may be larger in the area A1 than that in the area A2. FIG. 7 explains a modulation amount of a normalized phase in the radial direction of the substrate 1. In FIG. 7, the vertical axis represents a normalized phase, and the horizontal axis represents a position in the radial direction. FIG. 8 explains an uneven element width (for example, the diameter of a convex cylindrical element, etc.). In FIG. 8, the vertical axis represents an uneven element width, and the horizontal axis represents a position in the radial direction. In FIG. 8, the structure of the optical element 100 according to each example is illustrated by a solid line, and the structure of the optical element 101 according to the comparative example having no base layer 22 is illustrated by a dotted line.

Each example places the base layer 22 in the area A1, and makes larger the phase modulation amount than that in the area A2. Each example changes the uneven element width in each area, makes smaller a change amount in the uneven element width than that in the comparative example, and thereby suppresses the aspect ratios of the uneven element 21 in the areas A1 and A2. In a case where the phase modulation due to the uneven structure 2 in the area A1 is smaller than that in the area A2, the desired phase distribution or the aspect ratio suppression effect cannot be obtained unless the change amount in the uneven element width in the areas A1 and A2 is configured relatively large.

Referring now to FIGS. 9A and 9B, a description will be given of an element filling rate. FIGS. 9A and 9B explain the element filling rate. FIG. 9A illustrates the element filling rate in the area A1 having the base layer 22, and FIG. 9B illustrates the element filling rate in the area A2 having no base layer 22.

The element filling rate is a ratio of a volume occupied by the uneven structure 2 per segment. As illustrated in FIGS. 9A and 9B, the element filling rate in a range from the surface position of the substrate 1 in the area A1 or A2 to the position at the height HL from the surface positions of the substrate 1 are ratios of the base layer 22 or the uneven elements 21 to a volume Vs defined by a bottom surface P×P times a height HL. As illustrated in FIGS. 9A and 9B, the element filling rate in a range from the position at the height HL to the tip position of the uneven element 21 in the area A1 or A2 is a ratio of the base layer 22 or the uneven element 21 to a volume Va defined by the bottom surface P×P times a height H1.

At least one of the following inequalities (4) to (6) may be satisfied:

$$0.5 \leq V 1 s \leq 1. \qquad ( 4 )$$

$$0.8 \leq V 2 a / V 2 s \leq 1.2 \qquad ( 5 )$$

$$0.2 \leq V 1 a / V 1 s \leq 0.8 \qquad ( 6 )$$

where V1s is a maximum value of the element filling rate of the plurality of first structures from the surface position (surface) of the substrate 1 to the position at the height HL in the area A1, V2s is a maximum value of the element filling rate of the plurality of second structures from the surface position of the substrate 1 to the position at the height HL in the area A2, V1a is a maximum value of the element filling rate of the plurality of first structures from the position at the height HL to the tip position (tip) of the uneven structure 2 (structure) in the area A1, and V2a is a minimum value of the element filling rate of the plurality of first structures and the plurality of second structures from the position at the height HL to the tip position of the uneven structure 2 in each of the areas A1 and A2.

Inequality (4) relates to the element filling rate of the base layer 22 in the area A1. In a case where the value becomes lower than the lower limit of inequality (4), a desired phase modulation amount or the effect of suppressing the aspect ratio cannot be obtained unless the uneven element widths of the areas A1 and A2 are relatively significantly changed. From the definition of the element filling rate, V1s becomes maximum in a case where it becomes equal to Vs, so it never exceeds the upper limit of inequality (4). The lower limit of inequality (4) may be 0.54, 0.58, 0.62, 0.64, 0.68, 0.72, 0.76, 0.80, 0.82, 0.84, 0.86, 0.88, 0.90, 0.92, 0.94, or 0.96.

Inequality (5) relates to the element filling rate in the area A2. In a case where the value becomes lower than the lower limit of condition (5), V2s becomes relatively large, and a desired phase modulation amount or the effect of suppressing the aspect ratio cannot be obtained unless the uneven element width in the area A2 is significantly changed. On the other hand, in a case where the value becomes higher than the upper limit of inequality (5), V2a becomes relatively large, and the desired phase modulation amount or the effect of suppressing the aspect ratio cannot be obtained unless the width of the uneven elements 21 in the area A1 is significantly changed. In order to further secure the effects of each example, the lower limit of inequality (5) may be changed to 0.82, 0.84, 0.86, 0.88, 0.90, 0.92, 0.94, or 0.96. The upper limit of inequality (5) may be changed to 1.18, 1.16, 1.14, 1.12, 1.10, 1.08, 1.06, 1.04 or 1.02.

Inequality (6) relates to the element filling rate in the area A1. In a case where the value becomes lower than the lower limit of inequality (6), V1s becomes relatively large, and a desired phase modulation amount or the effect of suppressing the aspect ratio cannot be obtained unless the width of the uneven elements 21 in the area A2 is significantly changed. On the other hand, in a case where the value becomes higher than the upper limit of inequality (6), V1a becomes relatively large, and a desired phase modulation amount or the effect of suppressing the aspect ratio cannot be obtained unless the width of the uneven elements 21 in the area A1 is significantly changed. In order to further secure the effects of each example, the lower limit of inequality (6) may be changed to 0.21, 0.22, 0.23, 0.24, 0.25, 0.26, 0.27, 0.28, 0.29, or 0.30. The upper limit of inequality (6) may be changed to 0.78, 0.76, 0.74, 0.72, 0.70, 0.68, 0.66, or 0.65.

In each example, the following inequalities (7) and (8) may be satisfied:

$$1.05 \leq W max 1 / W min 1 \leq 6. \qquad ( 7 )$$

$$1.05 \leq W max 2 / W min 2 \leq 6.00 \qquad ( 8 )$$

where Wmax1 is a maximum width of the uneven element 21 (maximum diameter of the cylinder among the plurality of first structures) in the area A1, Wmin1 is a minimum width of the uneven element 21 (minimum diameter of the cylinder among the plurality of first structures) in the area A1, Wmax2 is a maximum width of the uneven element 21 (maximum diameter of the cylinder among the plurality of second structures) in the area A2, and Wmin2 is a minimum width of the uneven element 21 (minimum diameter of the cylinder among the plurality of second structures) in the area A2.

Inequalities (7) and (8) relate to the shapes of the uneven elements 21 in the areas A1 and A2, respectively. In a case where the value becomes lower than the lower limit of each of the inequalities (7) and (8), the phase modulation becomes relatively large due to a slight change in the uneven element width, the influence of manufacturing variations increases in forming the uneven structure 2, and manufacturing becomes difficult. On the other hand, in a case where the value becomes higher than the upper limit of each of the inequalities (7) and (8), the change amount in the uneven element width increases, and the effect of suppressing the aspect ratio cannot be obtained.

In order to further secure the effects of each example, the lower limit of inequality (7) may be changed to 1.10, 1.15, 1.20, 1.25, 1.30, 1.35, 1.40 or 1.45. The upper limit of inequality (7) may be changed to 5.50, 5.00, 4.50, 4.00, or 3.50.

In order to further secure the effects of each example, the lower limit of inequality (8) may be changed to 1.06, 1.08, 1.12, 1.16, 1.20, 1.24, 1.26, 1.28, 1.30, 1.32, 1.34, or 1.36. The upper limit of inequality (8) may be changed to 5.50, 5.00, 4.50, 4.00, 3.50, 3.00, 2.50, 2.00, 1.80, 1.70 or 1.60.

In each example, the phase modulation of the uneven elements 21 in the areas A1 and A2 may monotonically increase or decrease along the radial direction of the substrate 1 within the annulus section. That is, in each of the plurality of annulus sections, the plurality of first structures 215 and the plurality of second structures 216 are configured such that the phase of light passing through the uneven structure 2 monotonically increases or decreases in the radial direction. In a case where the phase modulation increases or decreases discretely, the uneven element width is to be relatively significantly changed and the effect of suppressing the aspect ratio cannot be obtained. In a case where the optical element 100 according to each example has a light condensing effect when a plane wave enters it in the thickness direction of the substrate 1, the phase modulation within the annulus section shows that a phase delay monotonously decreases in the radial direction from the inside of the substrate 1 to an outer circumference portion. In addition, in a case where the optical element 100 according to each example has a light diverging effect, the phase modulation within the annulus section shows that a phase delay monotonically increases in the radial direction from the inside of the substrate to the outer circumference portion.

In each example, the following inequality (9) may be satisfied:

$$0.35 \leq AR 1 / AR 2 \leq 2.00 \qquad ( 9 )$$

where AR1 is a maximum value of the aspect ratio of the uneven elements 21 in the area A1, and AR2 is a maximum value of the aspect ratio of the uneven elements 21 in the area A2.

Inequality (9) relates to the shape of the uneven element 21. In a case where the value becomes lower than the lower limit of inequality (9), the change amount in the uneven element width increases in the area A2, and the effect of suppressing the aspect ratio in the area A2 cannot be obtained. On the other hand, in a case where the value becomes higher than the upper limit of inequality (9), the change amount in the uneven element width increases in the area A1, and the effect of suppressing the aspect ratio in the area A1 cannot be obtained.

In order to further secure the effects of each example, the lower limit of inequality (9) may be changed to 0.36, 0.38, 0.40, 0.42, 0.43, or 0.44. The upper limit of inequality (9) may be changed to 1.90, 1.80, 1.70, 1.60, 1.50, 1.40, 1.30, 1.25 or 1.20.

In each example, the following inequalities (10) and (11) may be satisfied:

$$1.5 \leq A 1 \leq 20 \text{.00} \qquad ( 10 )$$

$$1.5 \leq A 2 \leq 20.00 \qquad ( 11 )$$

Inequalities (10) and (11) relate to the shapes of the uneven elements 21 in the areas A1 and A2. In a case where the value becomes lower than the lower limit of each of the inequalities (10) and (11), the phase modulation becomes relatively large even with a slight change in the uneven element width, the influence of manufacturing variations increases in forming the uneven structure 2, and manufacturing becomes difficult. On the other hand, in a case where the value becomes higher than the upper limit of each of the inequalities (10) and (11), the aspect ratio increases and the structure is likely to collapse due to external factors.

In order to further secure the effects of each example, the lower limits of inequalities (10) and (11) may be changed to 2.00, 3.00, 3.40, 3.80, 4.00, 4.20, 4.40, 4.60, 4.80, 5.00, or 5.20. The upper limits of inequalities (10) and (11) may be changed to 18.00, 16.00, 15.00, 14.00, 13.0, 12.0, 11.0, 10.0, 9.0 or 8.0.

In the optical element 100 according to each example, the phase distribution depends on the reference wavelength 20. The following inequality (12) may be satisfied:

$$0.5 \leq H 2 / λ 0 \leq 4.00 \qquad ( 12 )$$

Inequality (12) relates to the shape of the uneven structure 2. Regarding the phase distribution, annulus sections are determined based on the phase relative to the reference wavelength λ0. In a case where the value becomes lower than the lower limit of inequality (12), the change amount in the uneven element width increases, and the effect of suppressing the aspect ratio in the area A2 cannot be obtained. On the other hand, in a case where the value becomes higher than the upper limit of inequality (12), the aspect ratio increases and the structure is likely to collapse due to external factors.

In order to further secure the effects of each example, the lower limit of inequality (12) may be changed to 0.60, 0.70, 0.80, 0.90, 0.95 or 1.00. The upper limit of inequality (12) may be changed to 3.80, 3.60, 3.40, 3.20, 3.00, 2.80, 2.60, 2.40, 2.20 or 2.00.

The optical element 100 according to each example may satisfy the following inequality (13):

$$0.15 \leq W min 1 / W min 2 \leq 4.00 \qquad ( 13 )$$

Inequality (13) relates to the shape of the uneven element 21. In a case where the value becomes lower than the lower limit of inequality (13), the uneven element width in the area A1 becomes relatively small, and it becomes difficult to obtain the effect of suppressing the aspect ratio in the area A1. On the other hand, in a case where the value becomes higher than the upper limit of inequality (13), the uneven element width in the area A2 becomes relatively small, and it becomes difficult to obtain the effect of suppressing the aspect ratio in the area A2.

In order to further secure the effects of each example, the lower limit of inequality (13) may be changed to 0.16, 0.18, 0.20, 0.22, 0.24, 0.26, 0.28, or 0.29. The upper limit of inequality (13) may be changed to 3.75, 3.50, 3.25, 3.00, 2.75, 2.50, or 2.25.

The following inequality (14) may be satisfied:

$$0.7 \leq W max 1 / W max 2 \leq 1.4 \qquad ( 14 )$$

Inequality (14) relates to the shape of the uneven element 21. In a case where the value becomes lower than the lower limit of inequality (14), the maximum width of the uneven elements 21 in the area A1 becomes relatively small. Therefore, in order to change the predetermined normalized phase in the area A1, the minimum width of the uneven elements 21 is to reduce, and it becomes difficult to obtain the effect of suppressing the aspect ratio. On the other hand, in a case where the value becomes higher than the upper limit of inequality (14), the maximum width of the uneven elements 21 in the area A2 becomes relatively small. Therefore, in order to change the predetermined normalized phase in the area A2, the minimum width of the uneven elements 21 is to be reduced, and it becomes difficult to obtain the effect of suppressing the aspect ratio in the area A2.

In order to further secure the effects according to each example, the lower limit of inequality (14) may be changed to 0.74, 0.78, 0.82, 0.84, 0.85, 0.86 or 0.87. The upper limit of inequality (14) may be changed to 1.36, 1.32, 1.30, 1.28, 1.26, 1.24, 1.22, or 1.20.

The following inequality (15) may be satisfied:

$$0.10 \leq P / H 2 \leq 0.60 \qquad ( 15 )$$

Inequality (15) relates to the shapes of the uneven element 21 and the segment shape. In a case where the value becomes lower than the lower limit of inequality (15), the segment of the uneven elements 21 becomes relatively small, and a slight change in the uneven element width increases the phase modulation. As a result, the influence of manufacturing variations increases in forming the uneven structure 2, and manufacturing becomes difficult. On the other hand, in a case where the value becomes higher than the upper limit of inequality (15), the height of the uneven element 21 in the area A2 becomes high, and it becomes difficult to sufficiently obtain the effect of suppressing the aspect ratio.

In order to further secure the effects of each example, the lower limit of inequality (15) may be changed to 0.12, 0.14, 0.15, 0.16, 0.17, or 0.18. The upper limit of inequality (15) may be changed to 0.58, 0.56, 0.54, 0.52, 0.50, 0.48, 0.46, 0.44, or 0.42.

The following inequality (16) may be satisfied:

$$0.15 \leq E / n \leq 0.95 \qquad ( 16 )$$

where E is a normalized phase at the boundary between the areas A1 and A2 in the same annulus section, and n is a designed diffraction order.

Inequality (16) relates to a normalized phase of a diffraction effect. In a case where the value becomes lower than the lower limit of inequality (16), a change amount in the normalized phase in the area A1 increases, a width change amount of the uneven elements 21 in the area A1 is to be increased, and it becomes difficult to obtain the effect of suppressing the aspect ratio. On the other hand, in a case where the value becomes higher than the upper limit of inequality (16), a change amount increases in the normalized phase in the area A2, a width change amount of the uneven elements 21 in the area A2 is to be increased, and it becomes difficult to obtain the effect of suppressing the aspect ratio.

In order to further secure the effects of each example, the lower limit of inequality (16) may be changed to 0.16, 0.20, 0.24, 0.28, 0.30, 0.32, 0.34, 0.36, or 0.38. The upper limit of inequality (16) may be changed to 0.94, 0.93, 0.92, 0.91, 0.90, 0.89, 0.88, 0.87, 0.86, 0.85, 0.84, 0.83, or 0.82.

In each example, the following inequality (17) may be satisfied:

$$0. \leq H 2 / t \leq 0.10 \qquad ( 17 )$$

where t is a thickness of the substrate 1 in the optical axis direction.

Inequality (17) relates to the shape of the optical element 100. The height H2 of the uneven element 21 in the area A2 and the thickness t of the substrate 1 are both numerical values indicating length, and are larger than zero. Therefore, the value never becomes lower than the lower limit of inequality (17). In a case where the value becomes higher than the upper limit of inequality (17), the substrate becomes relatively thin, and deformation due to its own weight cannot be suppressed when the substrate is held by a holder, or the substrate may deform during manufacturing using lithography technology.

In order to further secure the effects of each example, the lower limit of inequality (17) may be changed to 0.000001, 0.000005, 0.00001, or 0.0001. The upper limit of inequality (17) may be changed to 0.08, 0.06, 0.04, 0.02, 0.01, 0.008, 0.006, or 0.004.

The following inequality (18) may be satisfied:

$$0. \leq S / P \leq 0.4 \qquad ( 18 )$$

where S is a length in a direction orthogonal to a thickness direction of the substrate 1, that is, in a direction orthogonal to the optical axis from the boundary between the segments arranged at the pitch P to the end of base layer 22 at the boundary between the areas A1 and A2 in the same annulus section.

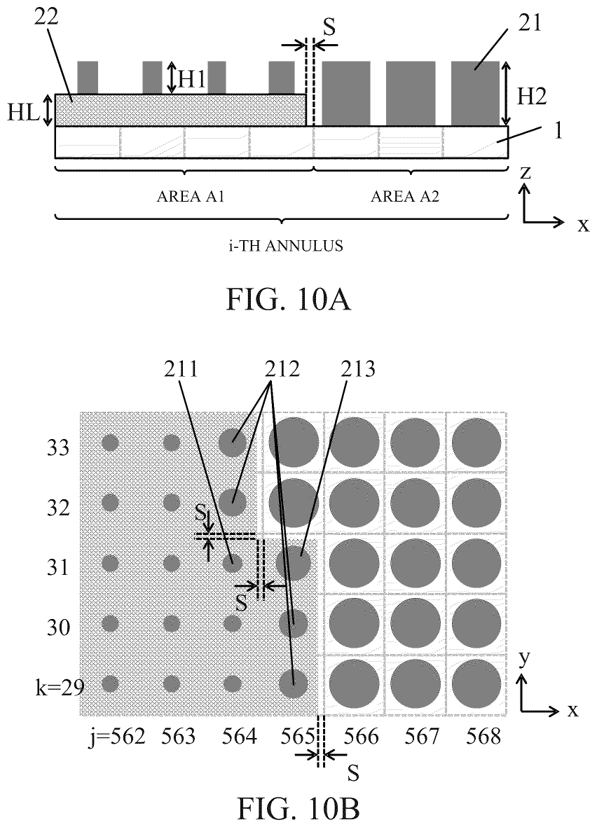

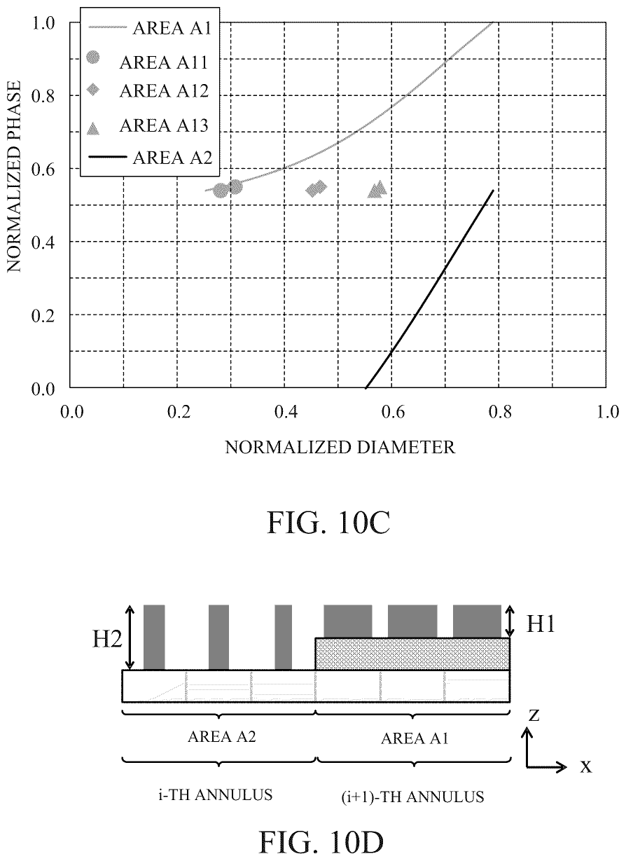

Inequality (18) relates to the shape of the base layer 22. Referring now to FIGS. 10A to 10D, a description will be given of the offset of the base layer 22. FIGS. 10A to 10D explain the offset of the base layer 22.

As illustrated in FIG. 10A, a sufficient distance can be secured between the uneven elements 21 in the area A2 and the base layer 22 by offsetting the end of the base layer 22 by the length S in the direction orthogonal to the optical axis from the segment boundary at the boundary between the areas A1 and A2 in the same annulus section. Thereby, in forming the uneven elements 21 using lithography technology, a distance (interval) between the uneven elements 21 or a distance between the uneven elements 21 and the base layer 22 can be relatively widely secured, and the process can be easy.

FIG. 10B is the xy plan view at the boundary between the areas A1 and A2 in the first annulus section according to Example 18, which will be described below. Each segment is a square with one side length of P, and the center coordinates (x, y) of the segment are ((j−0.5)×P, (k−0.5)×P), where each of i and k is an integer. In a segment including an uneven element 211 that contacts the area A1 at one vertex of the segment, the base layer may be offset by S in each of the x direction and y direction from the segment vertex that contacts the area A1. In a segment including an uneven element 212 that contacts the area A1 on one side of the segment, the base layer may be offset by S in the x or y direction from the segment side that contacts the area A1. In a segment including an uneven element 213 that contacts the area A1 at one vertex and two sides of the segment, the base layer may be offset by S in each of the x direction and the y direction from each segment side that contacts the area A1. In a segment in which the base layer 22 is offset, a phase change amount when light passes through the segment is different from that in a case where the segment is not offset, the uneven element width is to be changed according to the offset length S.

FIG. 10C illustrates a normalized diameter obtained by normalizing the diameter of the convex cylindrical element, which is the uneven element 21, by the segment pitch P, and a change amount in a normalized phase in a case where the offset of the base layer 22 is considered. A segment including the uneven element 211 will be referred to as an area A11, a segment including the uneven element 212 will be referred to as an area A12, and a segment including the uneven element 213 will be referred to as an area A13. It is understood that in order to obtain the same normalized phase as that of the area A1 having no offset of the base layer 22, the normalized diameter is to be changed in the areas A11, A12, and A13. Since the areas A11, A12, and A13 are located at the boundary between the areas A1 and A2 in the same annulus section, a value of the normalized phase for the normalized diameter at a position which corresponds to the boundary between the areas A1 and A2 is illustrated.

As illustrated in FIG. 10D, at the boundary between the areas A1 and A2 in adjacent annulus sections, the uneven element width of the area A2 is configured to be relatively narrow, and a sufficient distance can be secured from the base layer 22. Therefore, the end of the base layer 22 in the area A1 may not be offset from the segment boundary.

The offset length S and pitch P are both numerical values indicating lengths, and since they are values equal to or greater than 0, the value never becomes lower than the lower limit of inequality (18). In a case where the value becomes higher than the upper limit of inequality (18), a desired normalized phase cannot be obtained unless the uneven element width of the segment that offsets the base layer 22 is made relatively large. At this time, a sufficient distance cannot be secured from the end of the uneven element 21 to the offset end of the base layer 22, and manufacturing becomes difficult. Further, due to the overhang shape from the end of the base layer beyond the end of the uneven element, manufacturing becomes difficult.

In order to further secure the effects of each example, the lower limit of inequality (18) may be changed to 0.005, 0.01, 0.02, 0.04, 0.05, 0.06, 0.07, or 0.08. The upper limit of inequality (18) may be changed to 0.36, 0.32, 0.28, 0.24, 0.20, 0.18, 0.16, 0.14, or 0.12.

A detailed description will now be given of the optical element 100 according to each example.

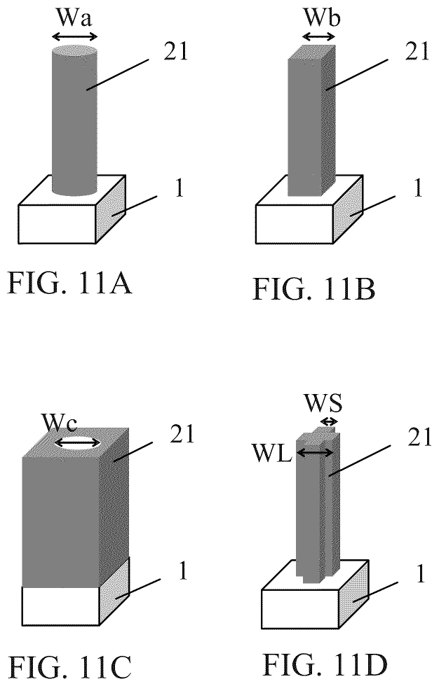

FIGS. 11A, 11B, 11C, and 11D explain the shape of the uneven elements 21. The uneven element 21 illustrated in FIG. 11A is a convex cylindrical element, and an uneven element width Wa is a diameter of the cylinder. The uneven element 21 illustrated in FIG. 11B is a convex rectangular (quadrangular) prism element, and an uneven element width Wb is a length of the side of the rectangular prism in the direction orthogonal to the optical axis. The uneven element 21 illustrated in FIG. 11C is a concave cylindrical element, and an uneven element width Wc is a diameter of a hollow cylinder. The uneven element 21 illustrated in FIG. 11D has a convex cross-shaped prism element, and uneven element widths WS and WL may be illustrated lengths.

An optical element according to Example 1 has an uneven structure that includes a substrate made of synthetic quartz and having a thickness of 0.775 mm, a convex cylindrical element made of Si₃N₄, and a base layer having a uniform film thickness. The uneven elements in the areas A1 and A2 are arranged for each square segment having a side of 240 nm, and have heights of 440 nm and 880 nm, respectively, and the height of the base layer is 440 nm. The uneven structure has an effective diameter of φ4.0 mm, 105 annulus sections in which a phase difference of 2π is periodically repeated at a wavelength of 500 nm, and a focal length of 40.0 mm. A position where a normalized phase is 0.54 is set to the boundary between the areas A1 and A2 in the annulus section, and the maximum values of the aspect ratios in the areas A1 and A2 are 7.24 and 6.64, respectively. Therefore, the aspect ratio can be suppressed in comparison with the maximum value of the aspect ratio of 20.7 in reference example 1 having no base layer.

An optical element according to Example 2 has an uneven structure that includes a substrate made of synthetic quartz and having a thickness of 0.775 mm, a convex cylindrical element made of Si₃N₄, and a base layer having a uniform film thickness. The uneven elements in the areas A1 and A2 are arranged for each square segment having a side of 300 nm, and have heights of 500 nm and 1000 nm, respectively, and the height of the base layer is 500 nm. The uneven structure has an effective diameter of φ2.5 mm, 67 annulus sections in which a phase difference of 2π is periodically repeated at a wavelength of 587.6 nm, and a focal length of 20.0 mm. A position where a normalized phase is 0.59 is set to the boundary between the areas A1 and A2 in the annulus section, and the maximum values of the aspect ratios in the areas A1 and A2 are 4.46 and 6.29, respectively. Therefore, the aspect ratio can be suppressed in comparison with the maximum value of the aspect ratio of 18.9 in reference example 2 having no base layer.

An optical element according to Example 3 has an uneven structure that includes a substrate made of synthetic quartz and having a thickness of 0.775 mm, a convex cylindrical element made of Si₃N₄, and a base layer having a uniform film thickness. The uneven elements in the areas A1 and A2 are arranged for each square segment having a side of 320 nm, and have heights of 800 nm and 1600 nm, respectively, and the height of the base layer is 800 nm. The uneven structure has an effective diameter of φ2.5 mm, 79 annulus sections in which a phase difference of 4π is periodically repeated at a wavelength of 500 nm, and a focal length of 10.0 mm. A position where a normalized phase is 0.80 is set to the boundary between the areas A1 and A2 in the annulus section, and the maximum values of the aspect ratios in the areas A1 and A2 are 5.88 and 9.80, respectively. Therefore, the aspect ratio can be suppressed in comparison with the maximum value of the aspect ratio of 21.3 in reference example 3 having no base layer.

An optical element according to Example 4 has an uneven structure that includes a substrate made of synthetic quartz and having a thickness of 0.775 mm, a convex cylindrical element of TiO₂, and a base layer having a uniform film thickness. The uneven elements in the areas A1 and A2 are arranged for each square segment having a side of 240 nm, and have heights of 300 nm and 600 nm, respectively, and the height of the base layer is 300 nm. The uneven structure has an effective diameter of φ12.0 mm, 307 annulus sections in which a phase difference of 2π is periodically repeated at a wavelength of 587.6 nm, and a focal length of 100.0 mm. A position where a normalized phase is 0.65 is set to the boundary between the areas A1 and A2 in the annulus section, and the maximum values of the aspect ratios in the areas A1 and A2 are 3.55 and 7.01, respectively. Therefore, the aspect ratio can be suppressed in comparison with the maximum value of the aspect ratio of 39.3 in reference example 4 having no base layer.

An optical element according to Example 5 has an uneven structure that includes a substrate made of synthetic quartz and having a thickness of 2.0 mm, a convex cylindrical element of Al₂O₃, and a base layer having a uniform film thickness. The uneven elements in the areas A1 and A2 are arranged for each square segment having a side of 300 nm, and have heights of 700 nm and 1400 nm, respectively, and the height of the base layer is 700 nm. The uneven structure has an effective diameter of φ7.5 mm, 348 annulus sections in which a phase difference of 2π is periodically repeated at a wavelength of 486.1 nm, and a focal length of 41.7 mm. A position where a normalized phase is 0.60 is set to the boundary between the areas A1 and A2 in the annulus section, and the maximum values of the aspect ratios in the areas A1 and A2 are 5.68 and 8.84, respectively. Therefore, the aspect ratio can be suppressed in comparison with the maximum value of the aspect ratio of 26.4 in reference example 5 having no base layer.

Optical elements according to Examples 6 to 10 have specifications similar to those of the optical elements according to Examples 1 to 5, respectively, except that the height of the uneven element in the area A1 and the height of the base layer are different.

The heights of the uneven element and the base layer in the area A1 of the optical element according to Example 6 are 352 nm and 528 nm, respectively. A position where a normalized phase is 0.58 is set to the boundary between the areas A1 and A2 in the annulus section, and the maximum values of the aspect ratios of the aspect ratios in the areas A1 and A2 are 5.02 and 5.83, respectively.

The heights of the uneven element and the base layer in the area A1 of the optical element according to Example 7 are 400 nm and 600 nm, respectively. A position where a normalized phase is 0.70 is set to the boundary between the areas A1 and A2 in the annulus section, and the maximum values of the aspect ratios in the areas A1 and A2 are 7.90 and 7.58, respectively.

The heights of the uneven element and the base layer in the area A1 of the optical element according to Example 8 are 640 nm and 960 nm, respectively. A position where a normalized phase is 1.40 is set to the boundary between the areas A1 and A2 in the annulus section, and the maximum values of the aspect ratios in the areas A1 and A2 are 5.32 and 12.47, respectively.

The heights of the uneven element and the base layer in the area A1 of the optical element according to Example 9 are 240 nm and 360 nm, respectively. A position where a normalized phase is 0.68 is set to the boundary between the areas A1 and A2 in the annulus section, and the maximum values of the aspect ratios in the areas A1 and A2 are 2.63 and 5.36, respectively.

The heights of the uneven element and the base layer in the area A1 of the optical element according to Example 10 are 560 nm and 840 nm, respectively. A position where a normalized phase is 0.58 is set to the boundary between the areas A1 and A2 in the annulus section, and the maximum values of the aspect ratios in the areas A1 and A2 are 9.86 and 7.97, respectively.

The optical elements according to Examples 11 to 15 have specifications similar to those of the optical elements according to Examples 1 to 5, except that the height of the uneven element in the area A1 and the height of the base layer are different.

The heights of the uneven element and the base layer in the area A1 of the optical element according to Example 11 are 528 nm and 352 nm, respectively. A position where a normalized phase is 0.55 is set to the boundary between the areas A1 and A2 in the annulus section, and the maximum values of the aspect ratios in the areas A1 and A2 are 6.49 and 7.94, respectively.

The heights of the uneven element and the base layer in the area A1 of the optical element according to Example 12 are 600 nm and 400 nm, respectively. A position where a normalized phase is 0.60 is set to the boundary between the areas A1 and A2 in the annulus section, and the maximum values of the aspect ratios in the areas A1 and A2 are 8.29 and 13.77, respectively.

The heights of the uneven element and the base layer in the area A1 of the optical element according to Example 13 are 960 nm and 640 nm, respectively. A position where a normalized phase is 1.60 is set to the boundary between the areas A1 and A2 in the annulus section, and the maximum values of the aspect ratios in the areas A1 and A2 are 5.37 and 15.92, respectively.

The heights of the uneven element and the base layer in the area A1 of the optical element according to Example 14 are 360 nm and 240 nm, respectively. A position where a normalized phase is 0.60 is set to the boundary between the areas A1 and A2 in the annulus section, and the maximum values of the aspect ratios in the areas A1 and A2 are 3.62 and 11.99, respectively.

The heights of the uneven element and the base layer in the area A1 of the optical element according to Example 15 are 840 nm and 560 nm, respectively. A position where a normalized phase is 0.60 is set to the boundary between the areas A1 and A2 in the annulus section, and the maximum values of the aspect ratio in the areas A1 and A2 are 7.50 and 11.22, respectively.

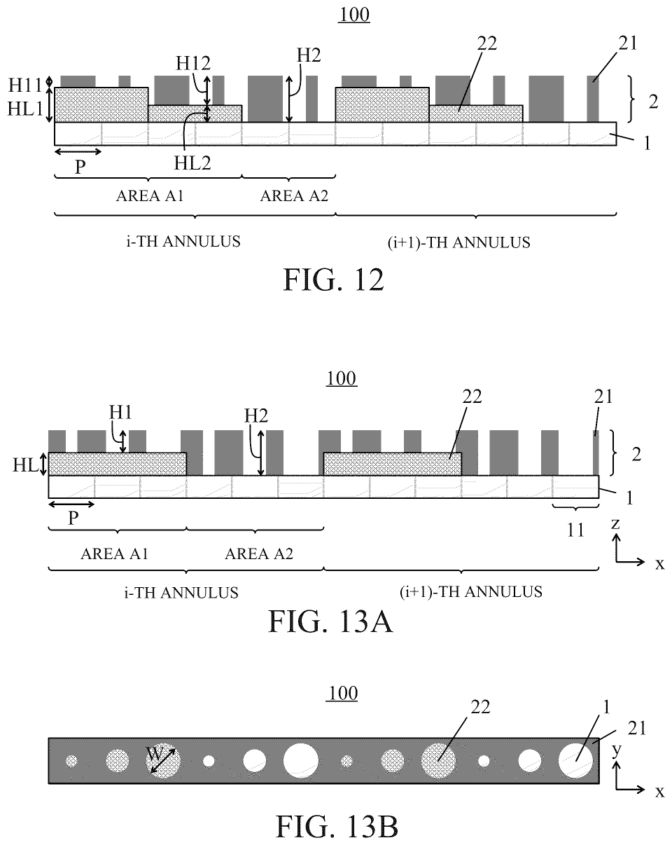

An optical element according to Example 16 has a specification similar to that of the optical element according to Example 1, except that the height of the uneven elements in the area A1 and the structure of the base layer are different. FIG. 12 explains the optical element 100 according to Example 16. As illustrated in FIG. 12, heights H11 and H12 of the uneven elements 21 and heights HL1 and HL2 of the base layer 22 have different structures, and the uneven elements 21 have heights of 352 nm and 528 nm, and the base layer 22 have heights of 528 nm and 352 nm. The position at which the base layer 22 has different heights in the area A1 in the annulus section is a position at which the normalized phase is 0.78, and the boundary between the areas A1 and A2 is a position where the normalized phase is 0.40. The maximum values of the aspect ratios in the area A1 are 3.07 and 5.29, and the maximum value of the aspect ratio in the area A2 is 6.37.

An optical element according to Example 17 has a specification similar to that of the optical element according to Example 1, except that the uneven element in the area A2 is a convex rectangular (quadrangular) prism element with a square cut surface in a plane orthogonal to the optical axis. Example 17 sets an area where the normalized phase is 0.60 to the boundary between the areas A1 and A2 in the annulus section, and the maximum values of the aspect ratios in the areas A1 and A2 are 7.33 and 8.05, respectively. The aspect ratio can be suppressed in comparison with the maximum value of the aspect ratio of 14.6 in reference example 6 having no base layer.

An optical element according to Example 18 has a specification similar to that of the optical element according to Example 1, except that the base layer boundary is offset by 24 nm from the segment boundary at the boundary between the areas A1 and A2 in the same annulus section. By offsetting the base layer boundary, a minimum distance between the base layer end and the uneven element in the area A2 is changed from 25.2 nm to 49.2 nm, and manufacturing becomes easy.

Example 18 sets a position where the normalized phase is 0.54 to the boundary between the areas A1 and A2 in the annulus section, and the maximum values of the aspect ratios in the areas A1 and A2 are 7.24 and 6.64, respectively. This example sets the offset length S to 24 nm, but may change the value to 5 nm, 10 nm, 15 nm, 20 nm, 30 nm, etc., as long as the uneven elements can be configured.

An optical element according to Example 19 has an uneven structure that includes a substrate made of synthetic quartz and having a thickness of 0.775 mm, a concave cylindrical element made of Si₃N₄, and a base layer having a uniform film thickness. FIG. 13A is a sectional view of the optical element 100 according to Example 19 in the xz plane, and FIG. 13B is a sectional view of the optical element 100 according to Example 19 in the xy plane. The uneven elements in the areas A1 and A2 are arranged for each square segment having a side of 300 nm, and have heights of 600 nm and 1200 nm, respectively, and the height of the base layer is 600 nm. The uneven structure has an effective diameter of +4.0 mm, 105 annulus sections in which a phase difference of 2π is periodically repeated at a wavelength of 500 nm, and a focal length of 40.0 mm. A position where a normalized phase is 0.65 is set to the boundary between the areas A1 and A2 in the annulus section, and the maximum values of the aspect ratios in the areas A1 and A2 are 11.98 and 7.06, respectively. Therefore, the aspect ratio can be suppressed in comparison with the maximum value of the aspect ratio of 28.2 in reference example 7 having no base layer.

Numerical examples 1 to 19 corresponding to the optical elements according to Examples 1 to 19 will be illustrated below. A phase, which indicates the light condensing and diverging effects of the uneven structure, is expressed as follows:

$$ϕ ( h ) = ( 2 π \frac{m}{{λ}_{0}} ) {\sum }_{k} {C}_{2 k} {h}^{2 k}$$

where h is a height from the optical axis in a direction orthogonal to the optical axis (radial direction), m is a diffraction order of diffracted light, λ0 is a reference wavelength, and Ck (k=1, 2, 3 . . . ) is a phase coefficient of each order.

nd, ng nC, nF, and n500 are refractive indices for the d-line (587.6 nm), g-line (435.8 nm), F-line (486.1 nm), and C-line (656.3 nm), and a wavelength of 500 nm. W1 [nm] and W2 [nm] are widths of the uneven elements in the areas A1 and A2, respectively, and Wref [nm] is a width of the uneven element in the comparative example.

NUMERICAL EXAMPLE 1

| NORMALIZED | | | |
|---|---|---|---|
| PHASE | W1 | W2 | Wref1 |
| 0.00 | | 132.45 | 43.48 |
| 0.05 | | 138.45 | 66.44 |
| 0.10 | | 144.15 | 82.23 |
| 0.15 | | 149.64 | 94.19 |
| 0.20 | | 154.97 | 104.04 |
| 0.25 | | 160.19 | 112.59 |
| 0.30 | | 165.32 | 120.22 |
| 0.35 | | 170.38 | 127.12 |
| 0.40 | | 175.42 | 133.44 |
| 0.45 | | 180.48 | 139.34 |
| 0.50 | | 185.58 | 144.96 |
| 0.54 | 60.79 | 189.62 | 149.33 |
| 0.60 | 95.31 | | 155.75 |
| 0.65 | 113.95 | | 161.01 |
| 0.70 | 128.17 | | 166.16 |
| 0.75 | 140.18 | | 171.21 |
| 0.80 | 150.87 | | 176.18 |
| 0.85 | 160.69 | | 181.18 |
| 0.90 | 170.11 | | 186.30 |
| 0.95 | 179.73 | | 191.56 |
| 1.00 | 189.57 | | 196.52 |

NUMERICAL EXAMPLE 2

| NORMALIZED | | | |
|---|---|---|---|
| PHASE | W1 | W2 | Wref2 |
| 0.00 | | 158.94 | 52.99 |
| 0.05 | | 166.78 | 82.77 |
| 0.10 | | 174.14 | 102.57 |
| 0.15 | | 181.20 | 117.34 |
| 0.20 | | 188.06 | 129.51 |
| 0.25 | | 194.79 | 140.16 |
| 0.30 | | 201.41 | 149.70 |
| 0.35 | | 207.90 | 158.33 |
| 0.40 | | 214.31 | 166.23 |
| 0.45 | | 220.76 | 173.58 |
| 0.50 | | 227.39 | 180.60 |
| 0.55 | | 234.24 | 187.44 |
| 0.59 | 112.09 | 239.58 | 192.84 |
| 0.65 | 141.54 | | 200.86 |
| 0.70 | 160.51 | | 207.43 |
| 0.75 | 177.02 | | 213.88 |
| 0.80 | 191.37 | | 220.27 |
| 0.85 | 203.86 | | 226.74 |
| 0.90 | 215.65 | | 233.51 |
| 0.95 | 228.05 | | 240.57 |
| 1.00 | 239.89 | | 247.29 |

NUMERICAL EXAMPLE 3

| NORMALIZED | | | |
|---|---|---|---|
| PHASE | W1 | W2 | Wref3 |
| 0.00 | | 163.26 | 74.98 |
| 0.10 | | 169.62 | 97.75 |
| 0.20 | | 175.83 | 112.71 |
| 0.30 | | 181.96 | 123.86 |
| 0.40 | | 188.08 | 133.16 |
| 0.50 | | 194.24 | 141.46 |
| 0.60 | | 200.53 | 149.09 |
| 0.70 | | 206.97 | 156.17 |
| 0.80 | 136.05 | 213.53 | 162.79 |
| 0.90 | 144.54 | | 169.10 |
| 1.00 | 151.29 | | 175.24 |
| 1.10 | 157.24 | | 181.34 |
| 1.20 | 162.72 | | 187.48 |
| 1.30 | 167.77 | | 193.72 |
| 1.40 | 172.49 | | 200.05 |
| 1.50 | 177.01 | | 206.51 |
| 1.60 | 181.51 | | 213.17 |
| 1.70 | 186.07 | | 220.20 |
| 1.80 | 190.64 | | 227.84 |
| 1.90 | 195.15 | | 236.23 |
| 2.00 | 200.02 | | 245.16 |

NUMERICAL EXAMPLE 4

| NORMALIZED | | | |
|---|---|---|---|
| PHASE | W1 | W2 | Wref4 |
| 0.00 | | 85.65 | 15.25 |
| 0.05 | | 101.98 | 67.65 |
| 0.10 | | 114.61 | 90.20 |
| 0.15 | | 125.27 | 103.58 |
| 0.20 | | 134.52 | 115.27 |
| 0.25 | | 142.73 | 126.60 |
| 0.30 | | 150.29 | 136.86 |
| 0.35 | | 157.51 | 145.42 |
| 0.40 | | 164.56 | 152.39 |
| 0.45 | | 171.42 | 158.51 |
| 0.50 | | 178.06 | 164.70 |
| 0.54 | | 183.29 | 170.12 |
| 0.60 | | 191.36 | 179.06 |
| 0.65 | 84.56 | 198.34 | 186.69 |
| 0.70 | 116.42 | | 193.72 |
| 0.75 | 136.38 | | 199.78 |
| 0.80 | 152.32 | | 205.26 |
| 0.85 | 165.61 | | 211.46 |
| 0.90 | 177.15 | | 219.59 |
| 0.95 | 189.20 | | 228.51 |
| 1.00 | 201.50 | | 230.08 |

NUMERICAL EXAMPLE 5

| NORMALIZED | | | |
|---|---|---|---|
| PHASE | W1 | W2 | Wref5 |
| 0.00 | | 158.36 | 52.97 |
| 0.05 | | 166.48 | 79.60 |
| 0.10 | | 174.23 | 97.81 |
| 0.15 | | 181.73 | 111.83 |
| 0.20 | | 189.07 | 123.73 |
| 0.25 | | 196.30 | 134.40 |
| 0.30 | | 203.39 | 144.17 |
| 0.35 | | 210.36 | 153.20 |
| 0.40 | | 217.21 | 161.61 |
| 0.45 | | 224.01 | 169.54 |
| 0.50 | | 230.87 | 177.15 |
| 0.54 | | 236.44 | 183.10 |
| 0.60 | 123.32 | 244.65 | 191.89 |
| 0.65 | 144.19 | | 199.09 |
| 0.70 | 161.62 | | 206.16 |
| 0.75 | 177.43 | | 213.07 |
| 0.80 | 191.96 | | 219.85 |
| 0.85 | 205.46 | | 226.63 |
| 0.90 | 218.72 | | 233.54 |
| 0.95 | 232.57 | | 240.59 |
| 1.00 | 245.90 | | 247.22 |

NUMERICAL EXAMPLE 6

| NORMALIZED | | |
|---|---|---|
| PHASE | W1 | W2 |
| 0.00 | | 151.05 |
| 0.05 | | 156.31 |
| 0.10 | | 161.49 |
| 0.15 | | 166.64 |
| 0.20 | | 171.76 |
| 0.25 | | 176.84 |
| 0.30 | | 181.89 |
| 0.35 | | 186.90 |
| 0.40 | | 191.94 |
| 0.45 | | 197.05 |
| 0.50 | | 202.25 |
| 0.55 | | 207.44 |
| 0.58 | 70.16 | 210.38 |
| 0.65 | 109.34 | |
| 0.70 | 126.54 | |
| 0.75 | 142.11 | |
| 0.80 | 156.88 | |
| 0.85 | 170.53 | |
| 0.90 | 183.79 | |
| 0.95 | 198.06 | |
| 1.00 | 211.04 | |

NUMERICAL EXAMPLE 7

| NORMALIZED | | |
|---|---|---|
| PHASE | W1 | W2 |
| 0.00 | | 132.01 |
| 0.05 | | 142.35 |
| 0.10 | | 151.62 |
| 0.15 | | 160.04 |
| 0.20 | | 167.81 |
| 0.25 | | 175.12 |
| 0.30 | | 182.14 |
| 0.35 | | 188.98 |
| 0.40 | | 195.70 |
| 0.45 | | 202.29 |
| 0.50 | | 208.77 |
| 0.54 | | 213.90 |
| 0.60 | | 221.64 |
| 0.65 | | 228.31 |
| 0.70 | 50.66 | 235.17 |
| 0.75 | 118.64 | |
| 0.80 | 152.47 | |
| 0.85 | 178.35 | |
| 0.90 | 200.04 | |
| 0.95 | 219.95 | |
| 1.00 | 239.89 | |

NUMERICAL EXAMPLE 8

| NORMALIZED | | |
|---|---|---|
| PHASE | W1 | W2 |
| 0.00 | | 128.27 |
| 0.10 | | 137.09 |
| 0.20 | | 145.00 |
| 0.30 | | 152.28 |
| 0.40 | | 159.10 |
| 0.50 | | 165.59 |
| 0.60 | | 171.88 |
| 0.70 | | 178.05 |
| 0.80 | | 184.17 |
| 0.90 | | 190.31 |
| 1.00 | | 196.51 |
| 1.10 | | 202.84 |
| 1.20 | | 209.41 |
| 1.30 | | 216.32 |
| 1.40 | 120.28 | 223.63 |
| 1.50 | 143.63 | |
| 1.60 | 159.94 | |
| 1.70 | 174.47 | |
| 1.80 | 188.44 | |
| 1.90 | 203.75 | |
| 2.00 | 223.92 | |

NUMERICAL EXAMPLE 9

| NORMALIZED | | |
|---|---|---|
| PHASE | W1 | W2 |
| 0.00 | | 111.87 |
| 0.05 | | 123.26 |
| 0.10 | | 133.24 |
| 0.15 | | 141.71 |
| 0.20 | | 149.02 |
| 0.25 | | 155.85 |
| 0.30 | | 162.77 |
| 0.35 | | 169.95 |
| 0.40 | | 177.14 |
| 0.45 | | 183.91 |
| 0.50 | | 190.13 |
| 0.55 | | 196.33 |
| 0.60 | | 203.43 |
| 0.68 | 91.15 | 215.18 |
| 0.70 | 105.66 | |
| 0.75 | 130.19 | |
| 0.80 | 151.59 | |
| 0.85 | 169.55 | |
| 0.90 | 183.43 | |
| 0.95 | 199.62 | |
| 1.00 | 215.64 | |

NUMERICAL EXAMPLE 10

| NORMALIZED | | |
|---|---|---|
| PHASE | W1 | W2 |
| 0.00 | | 175.65 |
| 0.05 | | 183.00 |
| 0.10 | | 190.27 |
| 0.15 | | 197.51 |
| 0.20 | | 204.71 |
| 0.25 | | 211.79 |
| 0.30 | | 218.67 |
| 0.35 | | 225.38 |
| 0.40 | | 232.02 |
| 0.45 | | 238.82 |
| 0.50 | | 245.92 |
| 0.55 | | 253.07 |
| 0.58 | 56.82 | 256.90 |
| 0.65 | 122.39 | |
| 0.70 | 147.19 | |
| 0.75 | 168.58 | |
| 0.80 | 188.48 | |
| 0.85 | 206.14 | |
| 0.90 | 222.66 | |
| 0.95 | 240.81 | |
| 1.00 | 257.76 | |

NUMERICAL EXAMPLE 11

| NORMALIZED | | |
|---|---|---|
| PHASE | W1 | W2 |
| 0.00 | | 110.85 |
| 0.05 | | 118.59 |
| 0.10 | | 125.58 |
| 0.15 | | 132.01 |
| 0.20 | | 138.04 |
| 0.25 | | 143.77 |
| 0.30 | | 149.29 |
| 0.35 | | 154.63 |
| 0.40 | | 159.84 |
| 0.45 | | 164.95 |
| 0.50 | | 170.02 |
| 0.55 | 81.32 | 175.10 |
| 0.60 | 99.50 | |
| 0.65 | 113.30 | |
| 0.70 | 125.22 | |
| 0.75 | 136.04 | |
| 0.80 | 145.86 | |
| 0.85 | 154.81 | |
| 0.90 | 163.32 | |
| 0.95 | 171.88 | |
| 1.00 | 179.95 | |

NUMERICAL EXAMPLE 12

| NORMALIZED | | |
|---|---|---|
| PHASE | W1 | W2 |
| 0.00 | | 72.61 |
| 0.05 | | 95.29 |
| 0.10 | | 111.80 |
| 0.15 | | 124.95 |
| 0.20 | | 136.14 |
| 0.25 | | 146.01 |
| 0.30 | | 154.90 |
| 0.35 | | 163.04 |
| 0.40 | | 170.63 |
| 0.45 | | 177.84 |
| 0.50 | | 184.81 |
| 0.55 | | 191.59 |
| 0.60 | 72.34 | 198.23 |
| 0.65 | 113.91 | |
| 0.70 | 141.68 | |
| 0.75 | 163.42 | |
| 0.80 | 181.55 | |
| 0.85 | 196.60 | |
| 0.90 | 209.56 | |
| 0.95 | 222.18 | |
| 1.00 | 233.93 | |

NUMERICAL EXAMPLE 13

| NORMALIZED | | |
|---|---|---|
| PHASE | W1 | W2 |
| 0.00 | | 100.48 |
| 0.10 | | 114.55 |
| 0.20 | | 125.47 |
| 0.30 | | 134.65 |
| 0.40 | | 142.79 |
| 0.50 | | 150.23 |
| 0.60 | | 157.17 |
| 0.70 | | 163.74 |
| 0.80 | | 170.07 |
| 0.90 | | 176.27 |
| 1.00 | | 182.40 |
| 1.10 | | 188.53 |
| 1.20 | | 194.71 |
| 1.30 | | 200.99 |
| 1.40 | | 207.48 |
| 1.50 | | 214.28 |
| 1.60 | 178.74 | 221.48 |
| 1.70 | 189.71 | |
| 1.80 | 200.78 | |
| 1.90 | 212.36 | |
| 2.00 | 223.94 | |

NUMERICAL EXAMPLE 14

| NORMALIZED | | |
|---|---|---|
| PHASE | W1 | W2 |
| 0.00 | | 50.05 |
| 0.05 | | 79.97 |
| 0.10 | | 97.72 |
| 0.15 | | 111.10 |
| 0.20 | | 122.41 |
| 0.25 | | 132.13 |
| 0.30 | | 140.54 |
| 0.35 | | 148.11 |
| 0.40 | | 155.34 |
| 0.45 | | 162.51 |
| 0.50 | | 169.56 |
| 0.55 | | 176.29 |
| 0.60 | 99.54 | 182.71 |
| 0.65 | 118.07 | |
| 0.70 | 133.58 | |
| 0.75 | 148.31 | |
| 0.80 | 161.23 | |
| 0.85 | 171.92 | |
| 0.90 | 182.13 | |
| 0.95 | 194.01 | |
| 1.00 | 203.77 | |

NUMERICAL EXAMPLE 15

| NORMALIZED | | |
|---|---|---|
| PHASE | W1 | W2 |
| 0.00 | | 124.75 |
| 0.05 | | 135.29 |
| 0.10 | | 144.90 |
| 0.15 | | 153.80 |
| 0.20 | | 162.17 |
| 0.25 | | 170.15 |
| 0.30 | | 177.83 |
| 0.35 | | 185.27 |
| 0.40 | | 192.52 |
| 0.45 | | 199.62 |
| 0.50 | | 206.61 |
| 0.55 | | 213.56 |
| 0.60 | 112.01 | 220.45 |
| 0.65 | 131.35 | |
| 0.70 | 147.84 | |
| 0.75 | 162.63 | |
| 0.80 | 176.09 | |
| 0.85 | 188.39 | |
| 0.90 | 199.91 | |
| 0.95 | 211.15 | |
| 1.00 | 221.97 | |

NUMERICAL EXAMPLE 16

| NORMALIZED | | | |
|---|---|---|---|
| PHASE | W11 | W12 | W2 |
| 0.00 | | | 138.25 |
| 0.05 | | | 143.97 |
| 0.10 | | | 149.47 |
| 0.15 | | | 154.81 |
| 0.20 | | | 160.02 |
| 0.25 | | | 165.13 |
| 0.30 | | | 170.20 |
| 0.35 | | | 175.28 |
| 0.40 | | 99.88 | 180.31 |
| 0.45 | | 113.75 | |
| 0.50 | | 125.76 | |
| 0.54 | | 134.37 | |
| 0.60 | | 146.02 | |
| 0.65 | | 155.08 | |
| 0.70 | | 163.81 | |
| 0.78 | 114.69 | 176.91 | |
| 0.80 | 121.81 | | |
| 0.85 | 137.96 | | |
| 0.90 | 152.35 | | |
| 0.95 | 166.17 | | |
| 1.00 | 179.95 | | |

NUMERICAL EXAMPLE 17

| NORMALIZED | | | |
|---|---|---|---|
| PHASE | W1 | W2 | Wref6 |
| 0.00 | | 109.35 | 60.15 |
| 0.05 | | 115.29 | 73.38 |
| 0.10 | | 120.88 | 83.52 |
| 0.15 | | 126.19 | 91.89 |
| 0.20 | | 131.28 | 99.23 |
| 0.25 | | 136.22 | 105.89 |
| 0.30 | | 141.04 | 112.06 |
| 0.35 | | 145.76 | 117.84 |
| 0.40 | | 150.40 | 123.30 |
| 0.45 | | 154.97 | 128.50 |
| 0.50 | | 159.50 | 133.51 |
| 0.54 | | 163.11 | 137.42 |
| 0.60 | 60.07 | 168.56 | 143.16 |
| 0.65 | 90.24 | | 147.85 |
| 0.70 | 110.30 | | 152.46 |
| 0.75 | 125.32 | | 157.02 |
| 0.80 | 137.73 | | 161.53 |
| 0.85 | 148.59 | | 166.04 |
| 0.90 | 158.51 | | 170.61 |
| 0.95 | 168.10 | | 175.24 |
| 1.00 | 177.59 | | 179.85 |

NUMERICAL EXAMPLE 18

| NORMALIZED | | | | | |
|---|---|---|---|---|---|
| PHASE | W1 | W11 | W12 | W13 | W2 |
| 0.00 | | | | | 132.52 |
| 0.05 | | | | | 138.51 |
| 0.10 | | | | | 144.21 |
| 0.15 | | | | | 149.70 |
| 0.20 | | | | | 155.03 |
| 0.25 | | | | | 160.25 |
| 0.30 | | | | | 165.37 |
| 0.35 | | | | | 170.43 |
| 0.40 | | | | | 175.47 |
| 0.45 | | | | | 180.53 |
| 0.50 | | | | | 185.63 |
| 0.54 | 60.79 | 67.49 | 108.63 | 136.41 | 189.67 |
| 0.60 | 95.31 | 99.31 | 127.32 | 150.44 | |
| 0.65 | 113.95 | | | | |
| 0.70 | 128.17 | | | | |
| 0.75 | 140.18 | | | | |
| 0.80 | 150.87 | | | | |
| 0.85 | 160.69 | | | | |
| 0.90 | 170.11 | | | | |
| 0.95 | 179.73 | | | | |
| 1.00 | 189.57 | | | | |

NUMERICAL EXAMPLE 19

| NORMALIZED | | | |
|---|---|---|---|
| PHASE | W1 | W2 | Wref7 |
| 0.00 | | 257.49 | 257.49 |
| 0.10 | | 246.63 | 246.63 |
| 0.20 | | 240.96 | 240.96 |
| 0.30 | | 238.67 | 238.67 |
| 0.40 | | 237.14 | 237.14 |
| 0.50 | | 234.23 | 234.23 |
| 0.60 | | 228.80 | 228.80 |
| 0.70 | | 220.82 | 220.82 |
| 0.80 | | 211.13 | 211.13 |
| 0.90 | | 200.96 | 200.96 |
| 1.00 | | 191.50 | 191.50 |
| 1.10 | | 184.92 | 184.92 |
| 1.20 | | 176.60 | 176.60 |
| 1.30 | 226.77 | 170.00 | 170.00 |
| 1.40 | 220.77 | | 161.81 |
| 1.50 | 210.77 | | 149.89 |
| 1.60 | 190.59 | | 132.42 |
| 1.70 | 161.38 | | 108.89 |
| 1.80 | 130.43 | | 81.29 |
| 1.90 | 100.95 | | 55.45 |
| 2.00 | 50.09 | | 42.53 |

Tables 1 to 3C summarize various numerical values according to each example.

TABLE 1

| | Si₃N₄ | TiO₂ | Al₂O₃ | synthetic quartz |
|---|---|---|---|---|
| ng | 2.08394 | 2.48181 | 1.63759 | 1.46240 |
| nF | 2.06710 | 2.42034 | 1.63053 | 1.45876 |
| nd | 2.04580 | 2.35281 | 1.62153 | 1.45345 |
| nC | 2.03665 | 2.32645 | 1.61759 | 1.45084 |
| n500 | 2.06337 | 2.40780 | 1.62896 | 1.45790 |

TABLE 2

| | EXAMPLES | | | | |
|---|---|---|---|---|---|
| | 1, 6, 11, 16, | | | | EXAMPLES |
| | 17, 18, AND | EXAMPLES | EXAMPLES | EXAMPLES | 5, 10, AND |
| | 19 | 2, 7, AND 12 | 3, 8, AND 13 | 4, 9, AND 14 | 15 |
| λ0 | 500.0 | 587.6 | 500.0 | 587.6 | 486.1 |
| C2 | −1.249999E−02 | −2.500000E−02 | −5.000000E−02 | −5.000000E−03 | −1.200000E−02 |
| C4 | 3.395631E−04 | 0.000000E+00 | 0.000000E+00 | 0.000000E+00 | 0.000000E+00 |
| C6 | −1.203821E−04 | 0.000000E+00 | 0.000000E+00 | 0.000000E+00 | 0.000000E+00 |
| C8 | 0.000000E+00 | 0.000000E+00 | 0.000000E+00 | 0.000000E+00 | 0.000000E+00 |

TABLE 3A

| | EX. 1 | EX. 2 | EX. 3 | EX. 4 | EX. 5 | EX. 6 | EX. 7 |
|---|---|---|---|---|---|---|---|
| MATERIAL | Si₃N₄ | Si₃N₄ | Si₃N₄ | TiO₂ | Al₂O₃ | Si₃N₄ | Si₃N₄ |
| λ0 [nm] | 500 | 587.56 | 500 | 587.6 | 486.1 | 500 | 587.56 |
| P [nm] | 240 | 300 | 320 | 240 | 300 | 240 | 300 |
| H1 [nm] | 440 | 500 | 800 | 300 | 700 | 352 | 400 |
| H2 [nm] | 880 | 1000 | 1600 | 600 | 1400 | 880 | 1000 |
| HL [nm] | 440 | 500 | 800 | 300 | 700 | 528 | 600 |
| H1/H2 | 0.500 | 0.500 | 0.500 | 0.500 | 0.500 | 0.400 | 0.400 |
| (H1 + HL)/H2 | 1.000 | 1.000 | 1.000 | 1.000 | 1.000 | 1.000 | 1.000 |
| Wmin1[nm] | 60.8 | 112.1 | 136.0 | 84.6 | 123.3 | 70.2 | 50.7 |
| Wmax1[nm] | 189.6 | 239.9 | 200.0 | 201.5 | 245.9 | 211.0 | 239.9 |
| Wmin2[nm] | 132.4 | 158.9 | 163.3 | 85.7 | 158.4 | 151.1 | 132.0 |
| Wmax2[nm] | 189.6 | 239.6 | 213.5 | 198.3 | 244.7 | 210.4 | 235.2 |
| AR1 | 7.24 | 4.46 | 5.88 | 3.55 | 5.68 | 5.02 | 7.90 |
| AR2 | 6.64 | 6.29 | 9.80 | 7.01 | 8.84 | 5.83 | 7.58 |
| AR1/AR2 | 1.09 | 0.71 | 0.60 | 0.51 | 0.64 | 0.86 | 1.04 |
| Wmax1/Wmin1 | 3.12 | 2.14 | 1.47 | 2.38 | 1.99 | 3.01 | 4.74 |
| Wmax2/Wmin2 | 1.43 | 1.51 | 1.31 | 2.32 | 1.54 | 1.39 | 1.78 |
| N | 1 | 1 | 2 | 1 | 1 | 1 | 1 |
| V1s | 1.000 | 1.000 | 1.000 | 1.000 | 1.000 | 1.000 | 1.000 |
| V1a | 0.490 | 0.502 | 0.307 | 0.554 | 0.528 | 0.607 | 0.502 |
| V2s | 0.490 | 0.501 | 0.350 | 0.536 | 0.522 | 0.603 | 0.483 |
| V2a | 0.490 | 0.501 | 0.350 | 0.536 | 0.522 | 0.603 | 0.483 |
| V1a/V1s | 0.490 | 0.502 | 0.307 | 0.554 | 0.528 | 0.607 | 0.502 |
| V2a/V2s | 1.000 | 1.000 | 1.000 | 1.000 | 1.000 | 1.000 | 1.000 |
| H2/λ | 1.760 | 1.702 | 3.200 | 1.021 | 2.880 | 1.760 | 1.702 |
| Wmin1/Wmin2 | 0.459 | 0.705 | 0.833 | 0.987 | 0.779 | 0.464 | 0.384 |
| Wmax1/Wmax2 | 1.000 | 1.001 | 0.937 | 1.016 | 1.005 | 1.003 | 1.020 |
| P/H2 | 0.273 | 0.300 | 0.200 | 0.400 | 0.214 | 0.273 | 0.300 |
| E/n | 0.540 | 0.590 | 0.400 | 0.650 | 0.600 | 0.580 | 0.700 |
| t [mm] | 0.775 | 0.775 | 0.775 | 0.775 | 2.000 | 0.775 | 0.775 |
| H2/t | 0.0011 | 0.0013 | 0.0021 | 0.0008 | 0.0007 | 0.0011 | 0.0013 |
| S [nm] | 0.000 | 0.000 | 0.000 | 0.000 | 0.000 | 0.000 | 0.000 |
| S/P | 0.000 | 0.000 | 0.000 | 0.000 | 0.000 | 0.000 | 0.000 |

TABLE 3B

| | EX. 8 | EX. 9 | EX. 10 | EX. 11 | EX. 12 | EX. 13 | EX. 14 |
|---|---|---|---|---|---|---|---|
| MATERIAL | Si₃N₄ | TiO₂ | Al₂O₃ | Si₃N₄ | Si₃N₄ | Si₃N₄ | TiO₂ |
| λ0 [nm] | 500 | 587.6 | 486.1 | 500 | 587.56 | 500 | 587.6 |
| P [nm] | 320 | 240 | 300 | 240 | 300 | 320 | 240 |
| H1 [nm] | 640 | 240 | 560 | 528 | 600 | 960 | 360 |
| H2 [nm] | 1600 | 600 | 1400 | 880 | 1000 | 1600 | 600 |
| HL [nm] | 960 | 360 | 840 | 352 | 400 | 640 | 240 |
| H1/H2 | 0.400 | 0.400 | 0.400 | 0.600 | 0.600 | 0.600 | 0.600 |
| (H1 + HL)/H2 | 1.000 | 1.000 | 1.000 | 1.000 | 1.000 | 1.000 | 1.000 |
| Wmin1 [nm] | 120.3 | 91.1 | 56.8 | 81.3 | 72.3 | 178.7 | 99.5 |
| Wmax1 [nm] | 223.9 | 215.6 | 257.8 | 179.9 | 233.9 | 223.9 | 203.8 |
| Wmin2 [nm] | 128.3 | 111.9 | 175.7 | 110.8 | 72.6 | 100.5 | 50.1 |
| Wmax2 [nm] | 223.6 | 215.2 | 256.9 | 175.1 | 198.2 | 221.5 | 182.7 |
| AR1 | 5.32 | 2.63 | 9.86 | 6.49 | 8.29 | 5.37 | 3.62 |
| AR2 | 12.47 | 5.36 | 7.97 | 7.94 | 13.77 | 15.92 | 11.99 |
| AR1/AR2 | 0.43 | 0.49 | 1.24 | 0.82 | 0.60 | 0.34 | 0.30 |
| Wmax1/Wmin1 | 1.86 | 2.37 | 4.54 | 2.21 | 3.23 | 1.25 | 2.05 |
| Wmax2/Wmin2 | 1.74 | 1.92 | 1.46 | 1.58 | 2.73 | 2.20 | 3.65 |
| N | 2 | 1 | 1 | 1 | 1 | 2 | 1 |
| V1s | 1.000 | 1.000 | 1.000 | 1.000 | 1.000 | 1.000 | 1.000 |
| V1a | 0.385 | 0.634 | 0.580 | 0.442 | 0.478 | 0.385 | 0.566 |
| V2s | 0.384 | 0.631 | 0.576 | 0.418 | 0.343 | 0.376 | 0.455 |
| V2a | 0.384 | 0.631 | 0.576 | 0.418 | 0.343 | 0.376 | 0.455 |
| V1a/V1s | 0.385 | 0.634 | 0.580 | 0.442 | 0.478 | 0.385 | 0.566 |
| V2a/V2s | 1.000 | 1.000 | 1.000 | 1.000 | 1.000 | 1.000 | 1.000 |
| H2/λ | 3.200 | 1.021 | 2.880 | 1.760 | 1.702 | 3.200 | 1.021 |
| Wmin1/Wmin2 | 0.938 | 0.815 | 0.324 | 0.734 | 0.996 | 1.779 | 1.989 |
| Wmax1/Wmax2 | 1.001 | 1.002 | 1.003 | 1.028 | 1.180 | 1.011 | 1.115 |
| P/H2 | 0.200 | 0.400 | 0.214 | 0.273 | 0.300 | 0.200 | 0.400 |
| E/n | 0.700 | 0.680 | 0.580 | 0.550 | 0.600 | 0.800 | 0.600 |
| t [mm] | 0.775 | 0.775 | 2.000 | 0.775 | 0.775 | 0.775 | 0.775 |
| H2/t | 0.0021 | 0.0008 | 0.0007 | 0.0011 | 0.0013 | 0.0021 | 0.0008 |
| S [nm] | 0.000 | 0.000 | 0.000 | 0.000 | 0.000 | 0.000 | 0.000 |
| S/P | 0.000 | 0.000 | 0.000 | 0.000 | 0.000 | 0.000 | 0.000 |

TABLE 3C

| | EX. 15 | EX. 16 | | EX. 17 | EX. 18 | EX.19 |
|---|---|---|---|---|---|---|
| MATERIAL | Al₂O₃ | Si₃N₄ | | Si₃N₄ | Si₃N₄ | Si₃N₄ |
| λ0 [nm] | 486.1 | 500 | | 500 | 500 | 500 |
| P [nm] | 300 | 240 | | 240 | 240 | 300 |
| H1 [nm] | 840 | 352 | 528 | 440 | 440 | 600 |
| H2 [nm] | 1400 | 880 | | 880 | 880 | 1200 |
| HL [nm] | 560 | 528 | 352 | 440 | 440 | 600 |
| H1/H2 | 0.600 | 0.400 | 0.600 | 0.500 | 0.500 | 0.500 |
| (H1 + HL)/H2 | 1.000 | 1.000 | 1.000 | 1.000 | 1.000 | 1.000 |
| Wmin1 [nm] | 112.0 | 114.7 | 99.9 | 60.1 | 60.8 | 50.1 |
| Wmax1 [nm] | 222.0 | 180.0 | 176.9 | 177.6 | 189.6 | 226.8 |
| Wmin2 [nm] | 124.7 | 138.2 | | 109.3 | 132.5 | 170.0 |
| Wmax2 [nm] | 220.5 | 180.3 | | 168.6 | 189.7 | 257.5 |
| AR1 | 7.50 | 3.07 | 5.29 | 7.33 | 7.24 | 11.98 |
| AR2 | 11.22 | 6.37 | | 8.05 | 6.64 | 7.06 |
| AR1/AR2 | 0.67 | 0.48 | 0.83 | 0.91 | 1.09 | 1.70 |
| Wmax1/Wmin1 | 1.98 | 1.57 | 1.77 | 2.96 | 3.12 | 4.53 |
| Wmax2/Wmin2 | 1.77 | 1.30 | | 1.54 | 1.43 | 1.51 |
| n | 1 | 1 | | 1 | 1 | 1 |
| V1s | 1.000 | 1.000 | 1.000 | 1.000 | 1.000 | 1.000 |
| V1a | 0.430 | 0.442 | 0.427 | 0.430 | 0.490 | 0.449 |
| V2s | 0.424 | 0.443 | | 0.387 | 0.491 | 0.579 |
| V2a | 0.424 | 0.443 | | 0.387 | 0.491 | 0.579 |
| V1a/V1s | 0.430 | 0.442 | 0.427 | 0.430 | 0.490 | 0.449 |
| V2a/V2s | 1.000 | 1.000 | | 1.000 | 1.000 | 1.000 |
| H2/λ | 2.880 | 1.760 | | 1.760 | 1.760 | 2.400 |
| Wmin1/Wmin2 | 0.898 | 0.830 | 0.723 | 0.549 | 0.459 | 0.295 |
| Wmax1/Wmax2 | 1.007 | 0.998 | 0.981 | 1.054 | 0.999 | 0.881 |
| P/H2 | 0.214 | 0.273 | | 0.273 | 0.273 | 0.250 |
| E/n | 0.600 | 0.780 | 0.400 | 0.600 | 0.540 | 0.650 |
| t [mm] | 2.000 | 0.775 | | 0.775 | 0.775 | 0.775 |
| H2/t | 0.0007 | 0.0011 | | 0.0011 | 0.0011 | 0.0015 |
| S [nm] | 0.000 | 0.000 | 0.000 | 0.000 | 24.000 | 0.000 |
| S/P | 0.000 | 0.000 | 0.000 | 0.000 | 0.100 | 0.000 |

Table 4 illustrates numerical values representing the uneven structures according to comparative examples (reference examples 1 to 7) corresponding to the optical elements according to each example.

TABLE 4

| | Ref. | Ref. | Ref. | Ref. | Ref. | Ref. | Ref. |
|---|---|---|---|---|---|---|---|
| | Ex. 1 | Ex. 2 | Ex. 3 | Ex. 4 | Ex. 5 | Ex. 6 | Ex. 7 |
| MINIMUM | 43.5 | 53.0 | 75.0 | 15.3 | 53.0 | 60.2 | 42.5 |
| WIDTH | | | | | | | |
| [nm] | | | | | | | |
| MAXIMUM | 196.5 | 247.3 | 245.2 | 230.1 | 247.2 | 179.8 | 257.5 |
| WIDTH | | | | | | | |
| [nm] | | | | | | | |
| MAXIMUM | 20.2 | 18.9 | 21.3 | 39.3 | 26.4 | 14.6 | 28.2 |
| ASPECT | | | | | | | |
| RATIO | | | | | | | |

### Optical System

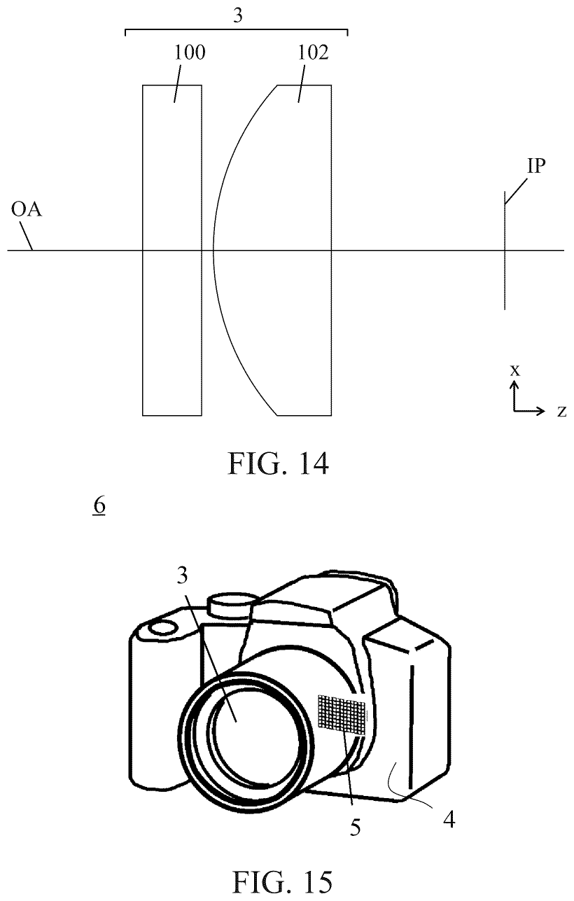

Referring now to FIG. 14, a description will be given of an optical system including the optical element according to any one of the above examples. FIG. 14 explains the optical system including the optical element according to any one of the above examples. In FIG. 14, reference numeral 100 denotes the optical element according to any one of the above examples, reference numeral 102 denotes a lens element, OA denotes an optical axis, IP denotes an image plane, and reference numeral 3 denotes the optical system including the optical element according to any one of the above examples. The lens element includes a lens, a diffractive optical element, a mirror, etc., and the number of lens elements is not limited. The optical element 100 and the lens element 102 are arranged along the optical axis OA to image incident light onto the image plane IP. The uneven element disposed on a surface on the image side of the optical element 100 can provide a light condensing or diverging effect.

### Image Pickup Apparatus

Referring now to FIG. 15, a description will now be given of a digital still camera (image pickup apparatus) using an optical system including the optical elements according to any one of the above examples as an imaging optical system. FIG. 15 explains an image pickup apparatus 6 having the optical system including the optical element according to any one of the above examples. In FIG. 15, reference numeral 4 denotes a camera body, and reference numeral 3 denotes the optical system including the optical element according to any one of the above examples. Reference numeral 5 denotes an image sensor (photoelectric conversion element), such as a CCD sensor or a CMOS sensor, which is built into the camera body 4, receives an optical image formed by the optical system 3, and photoelectrically converts it. The camera body 4 may be a so-called single-lens reflex camera having a quick return mirror, or a so-called mirrorless camera having no quick return mirror. Applying the optical system including the optical element according to each example to an image pickup apparatus such as a digital still camera in this way can provide an image pickup apparatus with a small lens.

Thus, an optical element according to one aspect of the example includes a plurality of annulus sections concentrically arranged on a substrate. The plurality of annulus sections including a first annulus section includes a first area where a base layer is provided, and a second area where the base layer is not provided. A plurality of first structures having mutually different widths in a radial direction are arranged in the first area. A plurality of second structures having mutually different widths in the radial direction are arranged in the second area. Thereby, each example can provide an optical element, an optical system, a lens apparatus, and an image pickup apparatus, each of which has a highly stable fine uneven structure.

While the disclosure has described example embodiments, it is to be understood that some embodiments are not limited to the disclosed embodiments. The scope of the following claims is to be accorded the broadest interpretation so as to encompass all such modifications and equivalent structures and functions.

This application claims priority to Japanese Patent Application No. 2023-117275, which was filed on Jul. 19, 2023, and which is hereby incorporated by reference herein in its entirety.

What is claimed is:

1. An optical element comprising:
a substrate; and
a plurality of annulus sections concentrically arranged on the substrate,
wherein the plurality of annulus sections include a first annulus section that includes a first area where a base layer is provided, and a second area where the base layer is not provided,
wherein a plurality of first structures having mutually different widths in a radial direction are arranged in the first area, and
wherein a plurality of second structures having mutually different widths in the radial direction are arranged in the second area.

2. The optical element according to claim 1, wherein the base layer is made of the same material as that of the plurality of first structures.

3. The optical element according to claim 1, wherein the following inequality is satisfied:
$$0. 20 \leq H 1 / H 2 \leq 0.90$$
where H1 is a height of each of the plurality of first structures, and H2 is a height of each of the plurality of second structures.

4. The optical element according to claim 1, wherein the following inequality is satisfied:
$$0.8 \leq ( H 1 + HL ) / H 2 \leq 1.2$$
where H1 is a height of each of the plurality of first structures, H2 is a height of each of the plurality of second structures, and HL is a height of the base layer.

5. The optical element according to claim 1, wherein a phase delay amount caused by the plurality of first structures for light incident perpendicularly to a surface of the substrate is larger than that caused by the plurality of second structures for the light.

6. The optical element according to claim 1, wherein the following inequalities are satisfied:
$$0.5 \leq V 1 s \leq 1.$$
$$0.8 \leq V 2 a / V 2 s \leq 1.2$$
where HL is a height of the base layer, V1s is a maximum value of a filling rate of the plurality of first structures in a range from a surface of the substrate to the height HL, V2s is a maximum value of a filling rate of the plurality of second structures in a range from the surface of the surface to the height HL, and V2a is a maximum value of a filling rate of the plurality of first structures and the plurality of second structures in a range from a position at the height HL to a corresponding one of tips of the plurality of first structures and the plurality of second structures.

7. The optical element according to claim 1, wherein the following inequality is satisfied:
$$0.2 \leq V 1 a / V 1 s \leq 0.8$$
where HL is a height of the base layer, V1s is a maximum value of a filling rate of the plurality of first structures in a range from a surface of the substrate to the height HL, and V1a is a maximum value of the filling rate of the plurality of first structures in a range from a position at the height HL to a tip of the plurality of first structures.

8. The optical element according to claim 1, wherein the following inequalities are satisfied:
$$1.05 \leq W max 1 / W min 1 \leq 6.$$
$$1.05 \leq W max 2 / W min 2 \leq 6.00$$
where Wmax1 and Wmin1 are a maximum width and a minimum width of the plurality of first structures, respectively, and Wmax2 and Wmin2 are a maximum width and a minimum width of the plurality of second structures, respectively.

9. The optical element according to claim 1, wherein a phase modulation amount caused by each of the plurality of first structures and the plurality of second structures monotonically changes in the radial direction.

10. The optical element according to claim 1, wherein the following inequality is satisfied:
$$0.35 \leq AR 1 / AR 2 \leq 2.00$$
where AR1 is a maximum value of an aspect ratio of the plurality of first structures, and AR2 is a maximum value of an aspect ratio of the plurality of second structures.

11. The optical element according to claim 1, wherein the following inequality is satisfied:
$$0.5 \leq H 2 / λ0 \leq 4.00$$
where H2 is a height of each of the plurality of second structures, and λ0 is a reference wavelength.

12. The optical element according to claim 1, wherein the following inequality is satisfied:
$$0.7 \leq W max 1 / W max 2 \leq 1.4$$
where Wmax1 is a maximum width of the plurality of first structures, and Wmax2 is a maximum width of the plurality of second structures.

13. The optical element according to claim 1, wherein the following inequality is satisfied:
$$0.10 \leq P / H 2 \leq 0.60$$
where P is an array period of the plurality of second structures in the radial direction, and H2 is a height of each of the plurality of second structures.

14. The optical element according to claim 1, wherein the following inequality is satisfied:
$$0.15 \leq E / n \leq 0.95$$
where E is a normalized phase at a boundary between the first area and the second area, and n is a designed diffraction order.

15. The optical element according to claim 1, wherein the following inequality is satisfied:
$$0. \leq H 2 / t \leq 0.10$$
where H2 is a height of each of the plurality of second structures, and t is a thickness of the substrate.

16. An optical system comprising a plurality of optical elements including the optical element according to claim 1.

17. A lens apparatus comprising:
the optical system according to claim 16; and
a holder configured to hold the optical system.

18. An image pickup apparatus comprising:
the optical system according to claim 16; and
an image sensor configured to receive an image formed by the optical system.
